(19) United States
(12) Patent Application Publication
(10) Pub. No.: US 2023/0289683 A1
(43) Pub. Date: Sep. 14, 2023

(54) SYSTEM AND METHOD FOR VALUING AND COMPARING CERTAIN CHOICES FOR PROJECT DEVELOPMENT

(71) Applicant: Payton Seats, Powell, OH (US)

(72) Inventor: Payton Seats, Powell, OH (US)

(21) Appl. No.: 18/082,241

(22) Filed: Dec. 15, 2022

Related U.S. Application Data
(60) Provisional application No. 63/318,250, filed on Mar. 9, 2022.
(60) Provisional application No. 63/330,027, filed on Apr. 12, 2022.

(51) Int. Cl. G06Q 10/0631

(52) U.S. Cl. CPC G06Q 10/06313

(57) ABSTRACT

Systems and methods are provided for valuing and comparing various choices for a major project. One example described, involves analyzing parcels of terrestrial space. More particularly, systems and methods incorporate the execution of multi-objective (“MO”) planning-driven functions to provide data useful for objectively valuing and comparing various choices for a project, such as parcels of terrestrial space, by way of example and not limitation, for land use planning and development. The MO planning is based on relevant quantitative criteria.

### CROSS-REFERENCE TO RELATED APPLICATIONS

This application claims priority to U.S. Provisional Application No. 63/318,250, filed Mar. 9, 2022, and U.S. Provisional Application No. 63/330,027, filed Apr. 12, 2022, the contents of which are hereby incorporated by reference as if fully recited herein.

### TECHNICAL FIELD

Embodiments of the present disclosure relate to a system and method for valuing and comparing various planning choices, for a wide variety of projects, in a new multi-objective, scientific analytical approach. In one example embodiment, multiple parcels of terrestrial space for planning and development are selected using the present invention. More particularly, the system and method involve execution of multi-objective (“MO”) planning-driven functions. In one example, pertinent data is collected and analyzed by objectively valuing and comparing various parcels of terrestrial space for planning and development, wherein the MO planning is based on relevant quantitative criteria.

### BACKGROUND AND SUMMARY OF THE INVENTION

Traditionally, major project planning and development, such as with respect to terrestrial space development (e.g., surface terrain, subsurface areas, aquatic space, atmospheric space, and the like) has generally involved arbitrary, subjective, and/or opinion-driven decision-making by planners, developers (e.g., corporations), regulators (e.g., governments and agencies thereof), and the like (collectively referred to as “decision makers”). Decision makers may include by way of example and not limitation, policymakers, analysts, engineers, professionals from any number of other disciplines, some combination thereof, or the like. An example of project planning and development may include by way of illustration and not limitation, house building. An example of subjective bias in house building may include, not by way of limitation, one deciding to build a house on a certain tract of land purely because the individual enjoys the scenery provided by that land. Another example of decision maker subjective bias is deciding to build on a certain tract of land only because that tract of land is in close proximity to another perceived desirable attraction (e.g., building a development of single-family homes designed for young families, near an elementary school). In recent history, decision makers have often had their actions dictated in part by laws and regulations concerning the terrestrial space, but in many cases, the decision-making processes still have lacked the objective influence of numerical data.

In the industrial era, planning and development to a large extent focused on, for example, proliferating buildings, roads, other infrastructure, mines, oil drilling sites, farmland, and the like by way of clearing natural space and collecting resources from natural space (and in many cases, those resources were depleted). The decision-makers were largely focused on maximizing economic development and financial gain, and lacked the knowledge and appreciation of today regarding the importance of sustainability, and mitigating and/or minimizing anthropogenic driven harms. In the present, post-industrial era, terrestrial space use still largely focuses on planning for and construction of resource collection sites, buildings, roads, other infrastructure, farmland, and the like, but concerns related to limited resource availability and environmental harms have grown considerably as a result of the massive, observable impact of human activity. Furthermore, in many regions, economic development concerns have grown as economic development relates to land use limitations. For example, in parts of the Appalachian region of the U.S., such as in the state of West Virginia, the decline of the mining industry has led to economic decline in certain communities, and thus concerns over how to revitalize the economy in those communities. Given present environmental concerns (and the existence of new laws and regulations stemming from those concerns), terrestrial space planning and development should focus on maximizing economic benefits while minimizing environmental harms. It is difficult if not impossible to achieve this focus without objectively considering numerical data pertaining to socioeconomic and environmental phenomena.

By way of example and not limitation, environmental concerns faced by decision makers today include water resource allocation, water supply depletion, fossil fuel-driven greenhouse gas emissions (and related mitigation), other air pollution, water pollution, solid waste concerns, deforestation and lumber supply depletion, destructive events like hurricanes, mudslides, forest fires, or the like, other resource depletion, population increase and mobility, and the like. Furthermore, socioeconomic concerns faced by decision makers today include by way of example and not limitation, tax issues and limited public funds, job loss related to waning industries such as the mining industry, the proliferation of reliance on government welfare assistance, limited job availability as a whole, limited land availability, education quality, infrastructure decline, housing availability, incentivizing people and entities to invest in their communities, healthcare, production of materials from raw resources, and the like.

Likewise, resource allocation focuses on dividing finite resources to where resources are most needed. It is difficult if not impossible to optimally allocate resources without comparing resource allocation planning objectives to information available about each of multiple choices for receiving resources. Finite resources include by way of example and not limitation, land, water, capital, labor, skillsets, data, some combination thereof, or the like. By way of example and not limitation, planning objectives may relate to food security, revenue generation, energy saving, carbon emission reduction, some combination thereof, or the like. As a specific non-limiting example, where an overarching goal of resource allocation/project development is food security, specific planning objectives thereof may include crop diversity, land utilization, crop revenue, some combination thereof, or the like. As another specific non-limiting example, where an overarching goal of resource allocation/project development involves co-management of blowdown water and produced water, specific planning objectives thereof may include produced water source accessibility, proximity of produced water source to blowdown water source, flow rate of produced water, some combination thereof, or the like. Resource allocation/project development goals may be achieved when resource use and allocation satisfies the planning objectives related to said goals.

In many cases, the facts relevant to project planning objectives may be characterized numerically and analyzed quantitatively. Traditionally, data analysis limitations made quantitative analysis of facts relevant to terrestrial space planning and development complicated or impossible for decision makers. For example, a plurality of spreadsheets each comprising numbers does little to inform decision making since decision makers likely do not know the significance of the numbers with respect to one another.

The recent development of digital mapping and geographic information systems (GISs) has made it possible to illustrate data geospatially in a way that a decision maker may better appreciate and understand the data, but digital mapping software and GISs in of themselves do not combine datasets to overlay and quantitatively characterize the relevance of certain values with respect to other values. The decision makers still lack a reliable multi-factor methodology for planning and development for major projects.

An emerging data analysis practice is multi-objective planning (“MO planning”). Model-driven MO planning involves combining numerical data using a plurality of calculations to provide information relevant to addressing a particular problem. Scientists, engineers, policy makers and decision makers are often tasked with addressing a problem that involves considering multiple, cross-disciplinary, often competing planning objectives. Model-driven MO approaches use programming methods that fit into the decision-making portion of a planning workflow. A problem (e.g., a non-limiting problem may include evaluating resource allocation for various parcels of land for crop development) is identified, defined, data is collected, alternatives are listed, and options are ranked by a quantitative model to be expressed to a decision maker. Known model-driven MO programming methods have included complex maximization and minimization algorithms, genetic algorithms, and several other highly complex methods.

An issue with known model-driven MO programming methods is that they involve a high level of computational complexity that makes it difficult if not impossible for many decision makers to understand what is being performed by the MO programming, or engage with the MO programming to perform one's own analysis. Another issue with known model-driven MO programming is the potential for a degenerate Pareto Front (a Pareto Front is a line of equal tradeoff between the objectives considered). For any MO problem, the dimension of the Pareto Front can be no larger than 1 less than the number of objectives. When this dimension is less than this number, the Pareto Front is said to be degenerate. The complex algorithms commonly used to solve MO allocation problems can become intractable and result in the emergence of a degenerate Pareto Front. Most often, this is the result of too many redundant or similar objectives. Similar objectives, such as, by way of example and not limitation, objective equations that model non-independent objectives, increase the risk of a degenerate pareto front forming. Thus, as the number of objectives increases, the risk of a degenerate Pareto Front also increases, as does the computational complexity of the MO programming.

The aforementioned shortcomings speak to the need for a more-accessible, compact, and simple framework for balancing objectives to make data-nuanced decisions. Decision makers currently lack an easy-to-use software system providing a multi-objective approach for major projects, such as terrestrial space planning and development.

In view of this, it is beneficial to have a system and method for valuing and comparing various choices, such as parcels of terrestrial space for planning and potential development thereof, wherein programming utilizing an MO approach-driven framework may be adapted to permit a user to collect, compare, and visually express data relevant to terrestrial space planning and development with ease.

It is an object of the present invention to provide a system and method for valuing and comparing various choices for a major project, such as parcels of terrestrial space. The system and method may comprise software adapted to improve at least one processor linked to at least one electronic display by providing a multi-objective approach driven framework permitting the collection, comparison, and visual expression of terrestrial space data, such as through one or more interfaces expressed by the electronic display.

According to the present invention in one aspect, an exemplary MO-driven software application is adapted to perform a plurality of functions on one or more processors. Numerical data concerning physical, environmental, social, economic, or the like phenomena of interest may be delivered to the processor, and thereafter the exemplary software may organize the data into multi-objective planning function (MOPF) matrices. An exemplary MOPF may have continuous and discrete forms, where the inputs of continuous forms may be functions (and the MOPF itself may act as a function of functions), and the inputs of discrete forms may be objective datasets (and the MOPF itself may act as a function of datasets). An exemplary MOPF may permit multiple options to be evaluated in accordance with a set of objectives. By way of example and not limitation, an exemplary MOPF may permit strategic allocation of a finite resource to reflect a set of objectives. The software may further be adapted to execute calculations to combine datasets to overlay and quantitatively characterize the relevance of certain data with respect to other data.

Exemplary software may also be adapted to save the values from MOPF calculations and permit geospatial illustration of the data, such as in the form of a GIS. By way of example and not limitation, a QGIS, ArcGIS, or the like geospatial rendering may provide geospatial illustration of the data. By way of illustration and not limitation, exemplary MOPF programming may be run in open-source OCTAVE language, MATLAB, or the like.

According to the present invention in one aspect, the exemplary software may be configured to permit the assignment of weighting multipliers to datasets, and may permit the sum of weighted terms normalized by the sum of their weights in the following MOPF equation:

$${π}_{ij} = \frac{1}{{ω}^{[ 1 ]} + {ω}^{[ 2 ]} + {ω}^{[ 3 ]} + …} \cdot ( \frac{{ω}^{[ 1 ]} \cdot {O}_{ij}^{[ 1 ]}}{{\sum }_{i = 1}^{n} {O}_{ij}^{[ 1 ]}} + \frac{{ω}^{[ 2 ]} \cdot {O}_{ij}^{[ 2 ]}}{{\sum }_{i = 1}^{n} {O}_{ij}^{[ 2 ]}} + \frac{{ω}^{[ 3 ]} \cdot {O}_{ij}^{[ 3 ]}}{{\sum }_{i = 1}^{n} {O}_{ij}^{[ 3 ]}} + … )$$

The aforementioned equation may permit multiple datasets to be normalized to one another for expression in a single rendering. The π term (also referred to herein as “π score,” an example of “MOPF result”) may represent a resource allocation scenario (a specific value, vector, matrix, equation or the like quantifying how a resource should be handled), desirability parameter, or the like. In certain embodiments, the lowest π score may represent an ideal site choice. In other embodiments, the highest π score may represent an ideal site choice. By having a plurality of π scores illustrated in a raster or vector image, a user may readily observe and identify relative geographic preferability across a particular terrestrial area.

Each term in an exemplary MOPF may relate to a specific objective dataset (e.g., Oᵢⱼ^{[1]}, Oᵢⱼ^{[2]}, etc.) and may be assigned a weighting multiplier (e.g., ω^{[1]}, ω^{[2]}, etc.). The weight may represent an individual planning objective's relative importance to other objectives in decision making. Each term may contain a product of the weighting multiplier (e.g., ω^{[2]}) and an objective dataset (e.g., Oᵢⱼ^{[2]}) divided by the sum of that expression (e.g., Σᵢ₌₁ⁿOᵢⱼ^{[2]}) to yield an objective term

$$( \frac{{ω}^{[ 1 ]} \cdot {O}_{ij}^{[ 1 ]}}{{\sum }_{i = 1}^{n} {O}_{ij}^{[ 1 ]}} ) .$$

The aforementioned equation illustrates a two-dimension (i,j) MOPF, but it will be apparent to one of ordinary skill in the art that any number of dimensions may be added to an exemplary MOPF without departing from the scope of the present invention. Each subsequent dimension may represent another way for a quantity of a resource to be organized. By way of example and not limitation, where crop tonnage is grouped by county grouped by state, an index (i) may be used for the dimension of crop tonnage, an index (j) may be used for the dimension of county, and an index (k) may be used for the dimension of state. It will also be apparent to one of ordinary skill in the art that modifications to the characters used to illustrate an exemplary MOPF may be made without departing from scope of the present invention.

In this particular MOPF, the objective datasets, weighting multipliers, and resource allocation scenario may be rewritten in vector/matrix notation:

$$π = \frac{1}{{\sum }_{θ = 1}^{N} {ω}^{[ θ ]}} \cdot {\sum }_{θ = 1}^{N} \frac{{ω}^{[ θ ]} \cdot {O}^{[ θ ]}}{sum ( {O}^{[ θ ]} , [ D ] )}$$

The bolded symbols represent vector or matrix quantities (terms with multiple dimensions). The index θ represents the number of objective terms (comprised of objective datasets O^{[θ}] and weighting multipliers ω^{[θ]}) from 1 to N (here, N represents the cardinality of co, or number of weighting multipliers, which is equal to the number of objective datasets). An objective dataset (e.g., O^{[θ]}) is not necessarily required to yield an objective term. By way of example and not limitation, a function (e.g., Fᵢ(x)) may replace an objective dataset to yield an objective term. In the example MOPF above, the denominator of the objective term (e.g., sum(O^{[θ]}, [D]) denotes the ability to sum the objective dataset over any number of dimensions ([D]). Objective dataset terms may comprise observed data or the output of some other model or expression.

In another example embodiment, the invention software may be utilized to execute MO planning to evaluate the benefits of applying a co-treatment approach for managing thermoelectric power plant blowdown (BD) water treatment and produced water (PW) treatment from natural gas production in an energy producing region. In the aforementioned embodiment, an exemplary MOPF may include the following:

$${π}_{ij} = \frac{1}{{α}_{ij} + {β}_{ij} + {γ}_{ij} + …} \cdot ( \frac{{α}_{ij} \cdot {A}_{ij}}{{\sum }_{i = 1}^{n} {A}_{ij}} + \frac{{β}_{ij} \cdot {B}_{ij}}{{\sum }_{i = 1}^{n} {B}_{ij}} + \frac{{γ}_{ij} \cdot {C}_{ij}}{{\sum }_{i = 1}^{n} {C}_{ij}} + … )$$

Here, the α, β, and γ symbols may represent the weighting factors, and the datasets may be produced water source distance (A) (ranked by i) from a thermoelectric power plant (represented by j), and produced water flow rate (B). (C) may be a hypothetical third metric. The π score may represent the desirability of a PW site choice.

In another example embodiment, the present invention may be utilized to execute MO planning to evaluate land slope, crop diversity, crop yield and sale price for the purpose of determining which existing and expandable arable lands sites are most ideal for agricultural development. In the aforementioned embodiment, an exemplary MOPF may include the following:

$${π}_{ijk} = \frac{1}{α + β + γ} ( \frac{α}{n ( k )} + \frac{β \cdot {Y}_{ij}}{{\sum }_{i = 1}^{n ( k )} {Y}_{ij}} + \frac{γ \cdot {R}_{ij}}{{\sum }_{i = 1}^{n ( k )} {R}_{ij}} )$$

Here, the α, β, and γ symbols represent the weighting factors, the first quotient in the parenthesis is crop diversity, the second quotient is crop yield, and the third quotient is revenue. The term n(k) is the number of different types of crop that are suitable for a given slope range k. Crop type is denoted by i and county is denoted by j. The π value (in this particular embodiment, resource allocation scenario) may be multiplied by the area of arable land in county j falling into slope category k and then multiplied by the overall crop yield for county j to yield a production scenario which may demonstrate the favorability of planting at different potential agricultural sites.

In another example embodiment, a sub-MOPF may be incorporated into a primary, overarching MOPF. In yet other example embodiments, statistical distributions may be incorporated into exemplary MOPFs. In yet other example embodiments, MOPFs may be applied even where certain relevant data is unknown. In yet another example embodiment, an MOPF may be derived to provide a real time value of a resource allocation scenario. In yet another example embodiment, exemplary MOPFs may be used to reflect both favorability and unfavourability values of particular choices. In various exemplary embodiments, project planning and development may focus on evaluating tradeoffs between multiple goals. By way of example and not limitation, when a certain amount of funding is available, and project objectives include both road construction and land conservation, there may be a tradeoff between promoting optimal road location and promoting land conservation. Exemplary MO Planning may permit quantification of relevant tradeoffs to promote optimal project planning and development.

Variable datasets that may be incorporated into an exemplary MOPF equation include by way of example and not limitation, States, areas within States, counties, developer preferences, highway locations, tax information, and the like. Some embodiments may provide for 6-15 factors to be considered. By way of example and not limitation, the present invention may be useful in identifying optimal terrestrial areas in the context of city planning, zoning, military strategy, eminent domain, highway development and construction, tax policy, utility services, and the like. In each case, an exemplary system or method of the present invention may be utilized to illustrate most favored sites by communicating from a processor one or more π values or subsequent values based on π value raster or vector images and related graphs or lists to at least one electronic display.

An overarching goal of exemplary MO Planning, at least with respect to decision making in the public sector space, may be promoting benefits to both the public and the natural environment. Decision makers in the public sector space may include by way of example and not limitation, elected officials, voters, professionals, some combination thereof, or the like. Exemplary MO Planning may permit decision makers to benefit from a streamlined approach for determining options most beneficial to the public and the natural environment, in view of applicable tradeoffs between competing benefits. Exemplary MO Planning may be based on objective data and criteria, and thus bias in decision making may be reduced or eliminated.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates exemplary logic of a preferred embodiment of the present invention;

FIG. 2 illustrates an exemplary MO programming template of the present invention;

FIG. 3 illustrates exemplary MOPFs and related functions of an exemplary MO programming module of an exemplary MO software application;

FIG. 4 illustrates exemplary logic of another preferred embodiment of the present invention;

FIG. 5 illustrates an exemplary geospatial graphic of MO programming input data in accordance with an exemplary embodiment of the present invention;

FIG. 6 illustrates an exemplary geospatial graphic of output data in accordance with an exemplary embodiment of the present invention;

FIG. 7 illustrates an exemplary graph of the present invention;

FIG. 8 illustrates another exemplary graph of the present invention;

FIG. 9 illustrates another exemplary graph of the present invention;

FIG. 10 illustrates another exemplary graph of the present invention;

FIG. 11 illustrates an exemplary graph representing exemplary MO programming input data in accordance with an exemplary embodiment of the present invention;

FIG. 12 illustrates another exemplary graph of the present invention;

FIG. 13 illustrates another exemplary graph of the present invention;

FIG. 14 illustrates another exemplary graph of the present invention;

FIG. 15 illustrates another exemplary graph of the present invention;

FIG. 16 illustrates exemplary MO programming of a particular exemplary embodiment of the present invention;

FIG. 17 illustrates exemplary MOPF results of the FIG. 16 embodiment;

FIG. 18 illustrates another exemplary geospatial graphic of another exemplary embodiment of the present invention;

FIG. 19 illustrates yet another exemplary geospatial graphic of the present invention;

FIG. 20 illustrates a pareto front in accordance with exemplary data analysis;

FIG. 21 illustrates exemplary MOPFs and related functions and logic according to exemplary MO programming;

FIG. 22 illustrates other exemplary MOPFs and related functions and logic according to an exemplary MO programming module of an exemplary MO software application;

FIG. 22B illustrates a graph of exemplary functions of the FIG. 22 embodiment;

FIG. 23 illustrates yet other exemplary MOPFs and related functions and logic according to an exemplary MO programming module of an exemplary MO software application;

FIG. 24 illustrates exemplary MOPF terms and results of the FIG. 23 embodiment;

FIG. 25 illustrates yet other exemplary MOPFs and related logic according to an exemplary MO programming module of an exemplary MO software application;

FIG. 26 illustrates exemplary data in accordance with an exemplary embodiment of the present invention;

FIG. 27 illustrates exemplary data of the FIG. 26 embodiment;

FIG. 28 illustrates exemplary data of the FIG. 26 embodiment;

FIG. 29 illustrates exemplary data of the FIG. 26 embodiment;

FIG. 30 illustrates other exemplary data of the FIG. 26 embodiment;

FIG. 31 illustrates exemplary MOPFs and related functions and logic according to an exemplary MO programming module of an exemplary MO software application;

FIG. 32 illustrates exemplary data of the FIG. 31 embodiment;

FIG. 33 illustrates exemplary data of the FIG. 31 embodiment;

FIG. 34 illustrates exemplary data of the FIG. 31 embodiment;

FIG. 35 illustrates exemplary logic related to an exemplary objective of the present invention;

FIG. 36 illustrates exemplary logic pertaining to considerations of decision makers;

FIG. 37 illustrates exemplary logic of a preferred embodiment of the present invention;

FIG. 38 illustrates exemplary logic of another preferred embodiment of the present invention;

FIG. 39 illustrates exemplary logic related to an exemplary objective of the present invention; and

FIG. 40 illustrates potential applications of exemplary MO planning.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

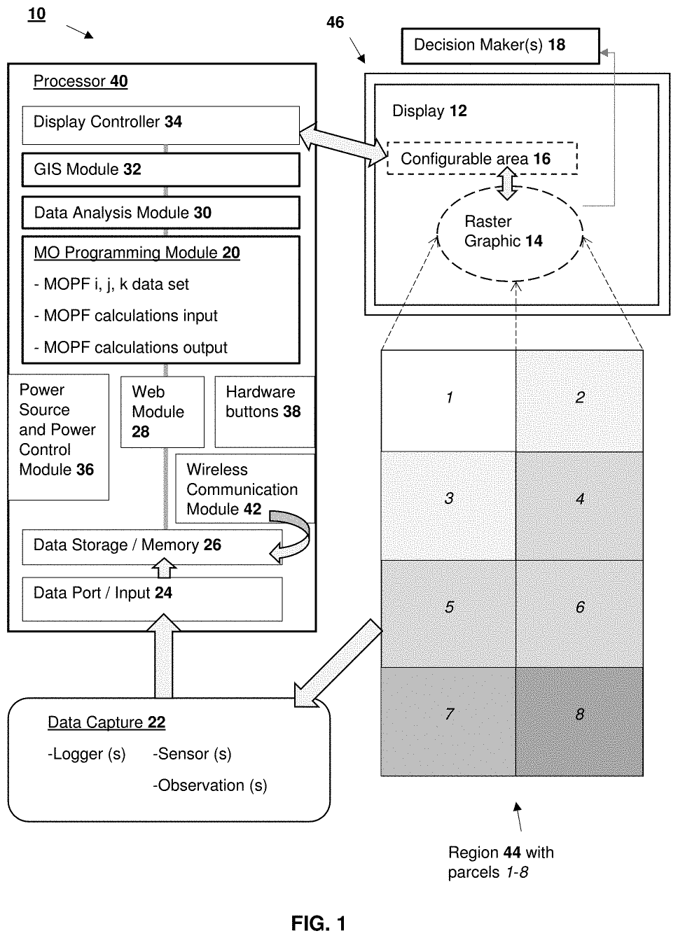

Referring now to FIG. 1, in an exemplary system for valuing and comparing parcels for planning and development 10, data pertaining to different parcels of terrestrial space 44 (parcels 1-8) may be captured 22 by sensors, observations, other research methods, data loggers, or the like, and exchanged to at least one processor 40 comprising a data port/input 24 for receiving said data pertaining to different parcels of terrestrial space 44. The data pertaining to different parcels of terrestrial space 44 may relate to any number of different physical, environmental, chemical, economic, or other relevant phenomena, including by way of example and not limitation, crop production, land slope, land elevation, groundwater availability, average precipitation, or the like. The processor 40 may be adapted to store to memory 26 data pertaining to the different parcels of terrestrial space. The processor 40 may comprise typical processor units such as a power source and power control module 36, hardware buttons, 38, wireless communication module 42, and display controller 34. The processor 40 may further comprise a web module 28 permitting, for example, web exchange of relevant data.

Exemplary software of the exemplary system for valuing and comparing parcels for planning and development 10 may include a MO programming module 20, a data analysis module 30, and a GIS module 32. An exemplary MO programming module may be adapted to execute any number of different MOPFs. An exemplary MOPF may have continuous and discrete forms, where the inputs of continuous forms may be functions (and the MOPF itself may act as a function of functions), and the inputs of discrete forms may be objective datasets (and the MOPF itself may act as a function of datasets). An exemplary MO programming module 20 may be adapted to organize various relevant datasets pertaining to terrestrial space planning or development into i, j, k, etc. vectors/matrices. The MO programming module 20 may further be adapted to assign each dataset to an MOPF. The MO programming module 20 may also be adapted to execute calculations of the MOPF, and communicate those calculations to a data analysis module 30 and or a GIS module 32. The data analysis module 30 may permit a user to organize the MOPF data visually and coherently so that the MOPF data may be interpreted or understood, such as to determine based on MOPF results which parcels of terrestrial space are most desirable for a particular objective. The GIS module 32 may also permit a user to organize the MOPF data visually and coherently, such as in the form of a geographic information system (raster or vector graphic 14), so that the MOPF data may be interpreted or understood. For example, by way of illustration and not limitation, each raster on a geospatial plot may comprise a color, and a darker color may indicate higher desirability for development.

The organized data from the MOPF calculations may be displayed on at least one monitor 46 or the like comprising an electronic display 12. The display 12 may comprise at least one configurable area 16 permitting a user to operate the exemplary software. Decision maker(s) 18 may utilize the exemplary system for valuing and comparing parcels for planning and development 10 by observing the organized data from the MOPF calculations to readily determine which parcel(s) of land are most desirable for a particular objective.

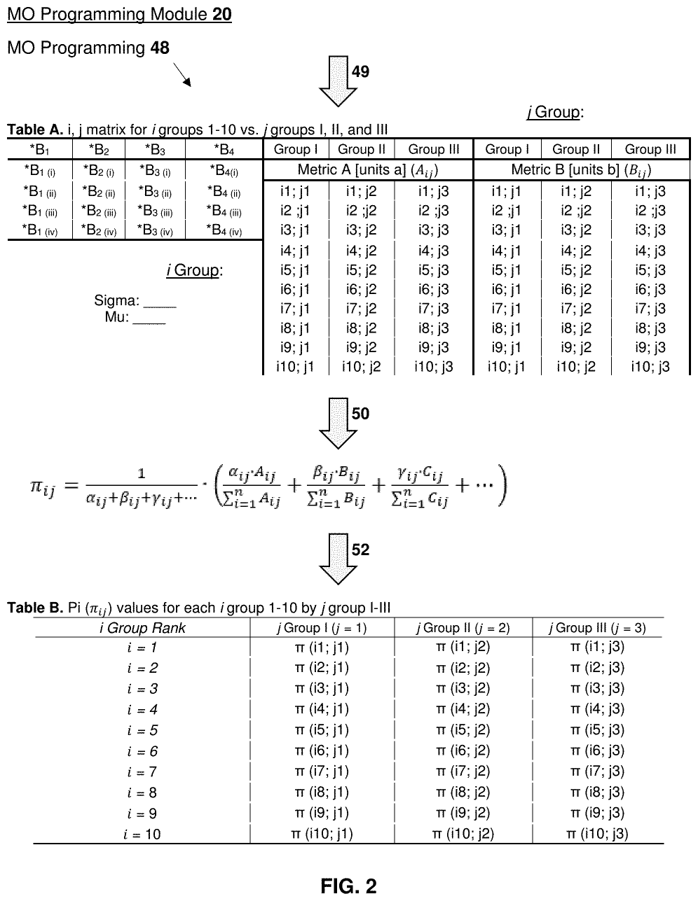

Referring now to FIG. 2, exemplary MO programming 48 of an exemplary MO programming module 20 of the present invention is shown. Data 49 may be directed to matrices for i, j, etc. groups. It will be apparent to one of ordinary skill in the art that exemplary software of the present invention provides for any number of metrics and/or dimensions in MO programming. Here, i and j groups are listed for two different metrics, A and B, and metric B data may be determined from *B₁₋₄ data. It will be apparent to one of ordinary skill in the art that any number of calculations may precede an exemplary MOPF to deliver to the MOPF desired data pertaining to parcels of interest. Exemplary MO programming may also provide sigma and mu values for, e.g., determining statistical significance of values.

Exemplary MO programming may further include at least one MOPF (shown below arrow 50, where values from table A are incorporated into the MOPF). In the embodiment shown, the exemplary software is configured to permit the assignment of weighting multipliers to datasets, and permit the sum of weighted terms normalized by the sum of their weights. Here, the α, β, and γ symbols represent the weighting factors, and the datasets are represented by A and B (hypothetical C is also included), corresponding to metrics A and B. i groups are ranked from 1-10 and j groups are ranked from 1-3. In certain embodiments, values of the weighting multipliers may be assigned based on input from one or more policymakers, voters, professionals, or the like, where said input may be related to perceived importance of each of various objective datasets. It will be apparent to one of ordinary skill in the art that there may be any number of different methods available for assigning weighting multipliers without departing from the scope of the present invention.

The MOPF may permit multiple datasets to be normalized to one another for expression in a single rendering (illustrated by Table B below arrow 52). In preferred embodiments, the π term may represent a resource allocation scenario, desirability parameter, or the like. In certain embodiments, the lowest π score may represent an ideal site choice. In other embodiments, the highest π score may represent an ideal site choice. The weight (α, β, and γ) may represent an individual planning objective's relative importance to other objectives in decision making. Each term may contain a product of the weighting multiplier and an objective dataset divided by the sum of that expression to yield an objective term

$$( \frac{{α}^{[ 1 ]} \cdot {A}_{ij}^{[ 1 ]}}{{\sum }_{i = 1}^{n} {A}_{ij}^{[ 1 ]}} ) .$$

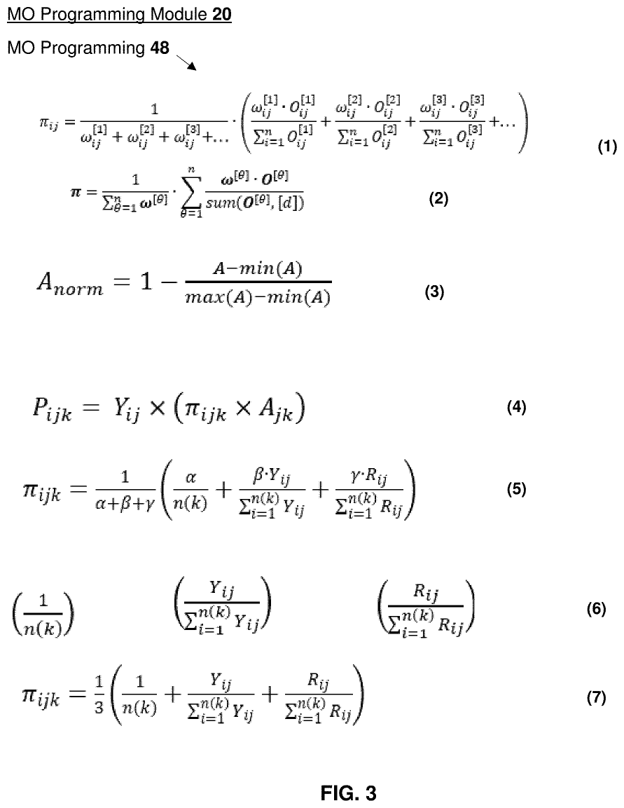

As illustrated in equations (1-2), (5), (6), and (7) of FIG. 3, in exemplary MO programming 48 of an exemplary MO programming module 20, objective terms may be summed and then normalized by being divided by the sum of the weighting factors to yield a π score, such as, by way of example and not limitation, to represent a resource allocation scenario.

Referring specifically to equation (1), a number of resources to be partitioned may be represented by the term (Σᵢ₌₁ⁿOᵢⱼ^{[1]}=n). By way of example and not limitation, resources to be partitioned may include parcels of land, sums of money in different departments, a list of resource locations, some combination thereof, or the like. Here, each subsequent term shown in the parenthesis contains the product of a weighting multiplier (e.g., ω^{[2]}) and objective dataset (e.g., Oᵢⱼ^{[2]}) divided by the sum of that expression (e.g., Σᵢ₌₁ⁿOᵢⱼ^{[2]}) to yield the objective term

$$( \frac{{ω}^{[ 2 ]} \cdot {O}_{ij}^{[ 2 ]}}{{\sum }_{i = 1}^{n} {O}_{ij}^{[ 2 ]}} ) .$$

In this particular embodiment, each π score from i=1 . . . n may be summed together to equal 1, such that each π score represents a proportion. The proportion may be multiplied by 100 to represent a percentage allocation for the particular choice represented by πᵢⱼ.

Equation (2) may represent equation (1) summed across a particular dimension D. Summing π scores across any particular dimension reflected in the denominator summation may provide a vector reflecting length of the index. This may be reflected by the following logic:

$${O}_{ij}^{[ 1 ]} = \{ \begin{matrix}8 & 7 & 4 \\ 2 & 2 & 7\end{matrix} \} , {ω}^{[ 1 ]} = \{ 1 \}$$

In this particular non-limiting example, the objective term Oᵢⱼ^{[1]} has i and j index values represented by the matrix above. By summing across the i dimension:

$${π}_{ij} = \frac{1}{{ω}^{[ 1 ]}} \cdot ( \frac{{ω}^{[ 1 ]} \cdot {O}_{ij}^{[ 1 ]}}{{\sum }_{i = 1}^{2} {O}_{ij}^{[ 1 ]}} ) ⇔ π = \frac{1}{{ω}^{[ 1 ]}} \cdot {\sum }_{θ = 1}^{n ( ω )} \frac{{ω}^{[ θ ]} \cdot {O}^{[ θ ]}}{sum ( {O}^{[ θ ]} , [ i ] )}$$

$${\sum }_{i = 1}^{2} {π}_{ij} = \{ \begin{matrix}1 & 1 & 1\end{matrix} \}$$

By summing across the j dimension:

$${π}_{ij} = \frac{1}{{ω}^{[ 1 ]}} \cdot ( \frac{{ω}^{[ 1 ]} \cdot {O}_{ij}^{[ 1 ]}}{{\sum }_{j = 1}^{3} {O}_{ij}^{[ 1 ]}} ) ⇔ π = \frac{1}{{ω}^{[ 1 ]}} \cdot {\sum }_{θ = 1}^{n ( ω )} \frac{{ω}^{[ θ ]} \cdot {O}^{[ θ ]}}{sum ( {O}^{[ θ ]} , [ j ] )} \\ {\sum }_{j = 1}^{3} {π}_{ij} = \{ \begin{matrix}1 \\ 1 \\ 1\end{matrix} \}$$

The above logic reflects that the sum of π scores across a dimension in the matrix is equal to 1. The following logic further illustrates that the sum of π scores across a dimension in the matrix is equal to 1:

$${π}_{ij} = \frac{1}{{α}_{ij}} \cdot ( \frac{{α}_{ij} \cdot {A}_{ij}}{{\sum }_{i = 1}^{2} {\sum }_{j = 1}^{3} {A}_{ij}} ) \\ {\sum }_{i = 1}^{2} {\sum }_{j = 1}^{3} {π}_{ij} = \{ 1 \}$$

Thus, in certain exemplary embodiments, π scores may be evaluated as a precise proportion value (e.g., resource allocation scenario value) to be compared with other precise proportion values for decision making. By way of example and not limitation, a π score may inform a percentage of a resource to be allocated to a particular location.

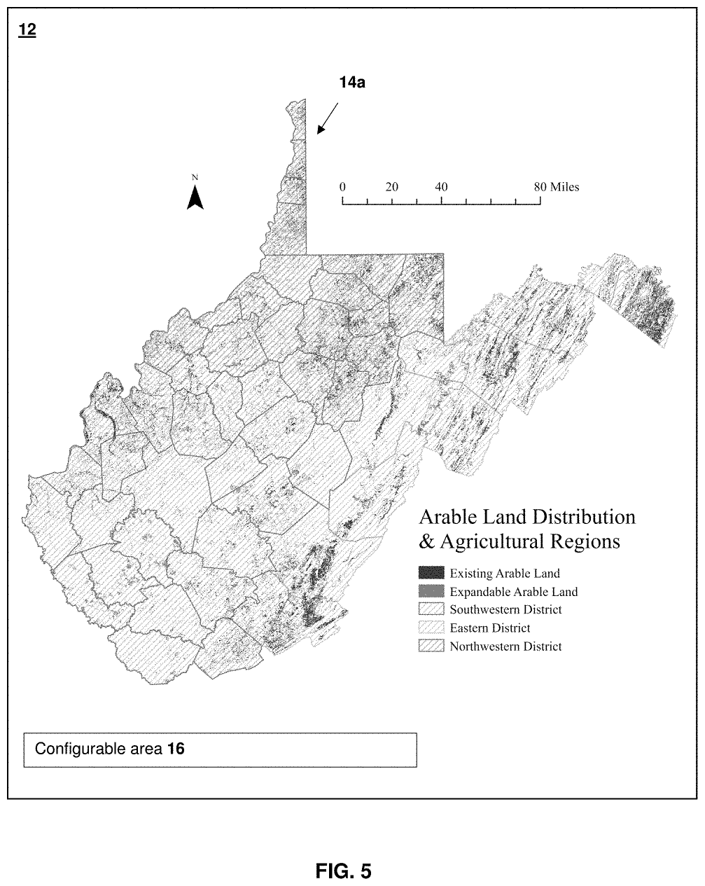

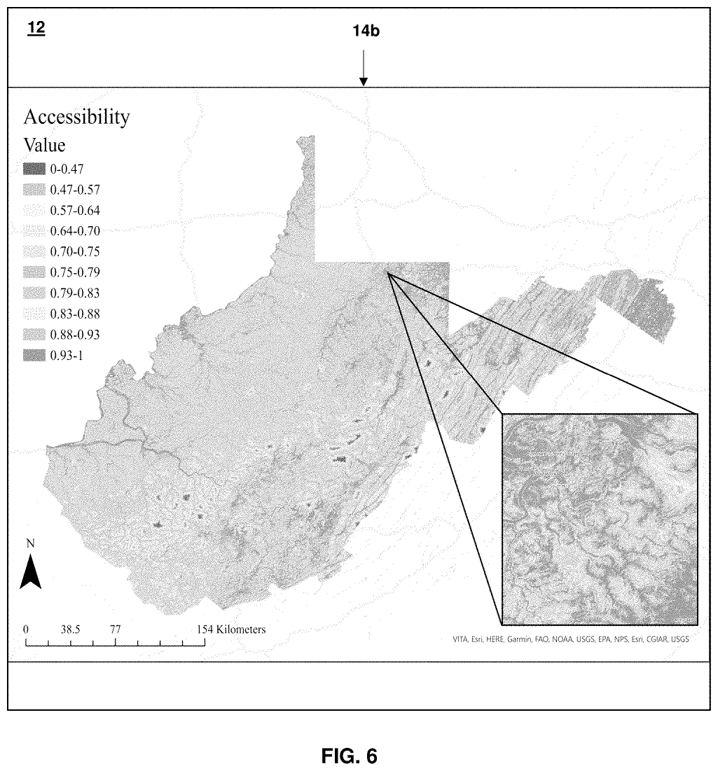

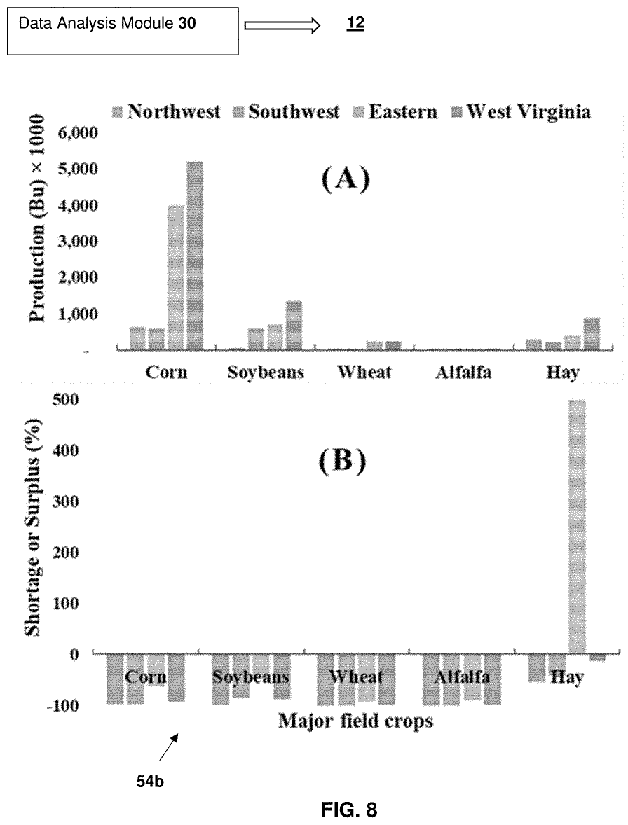

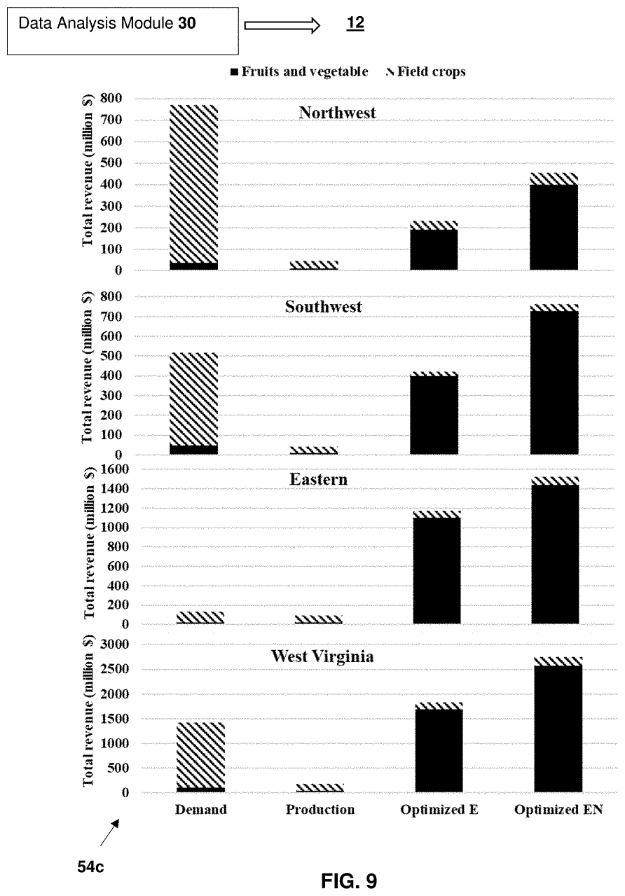

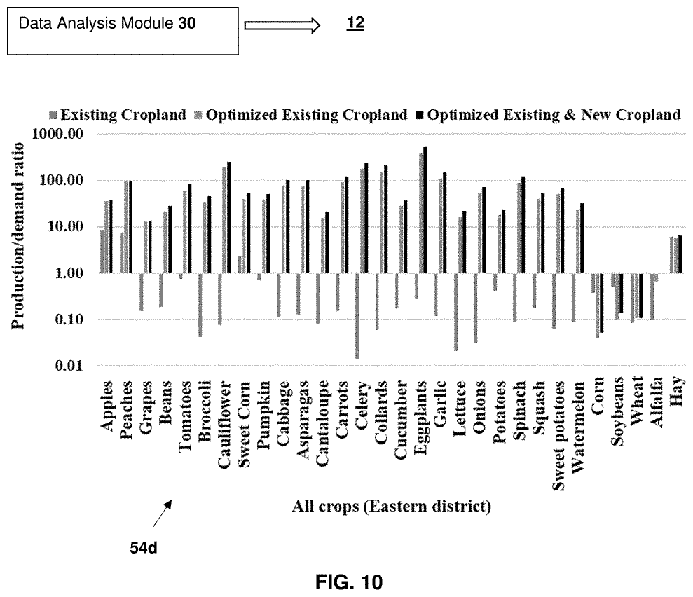

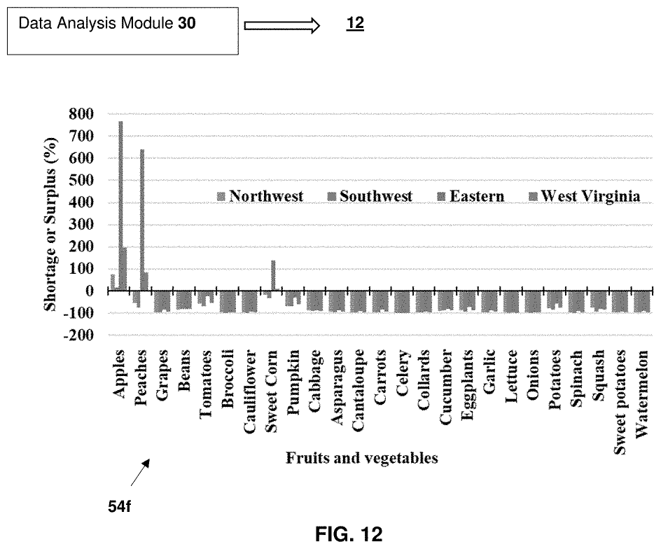

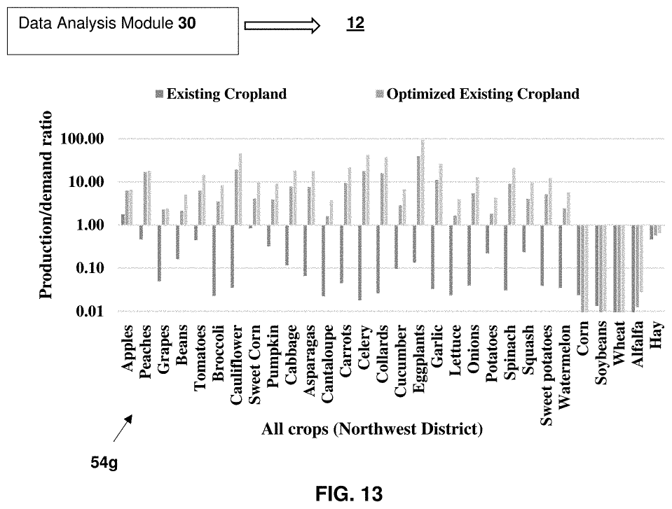

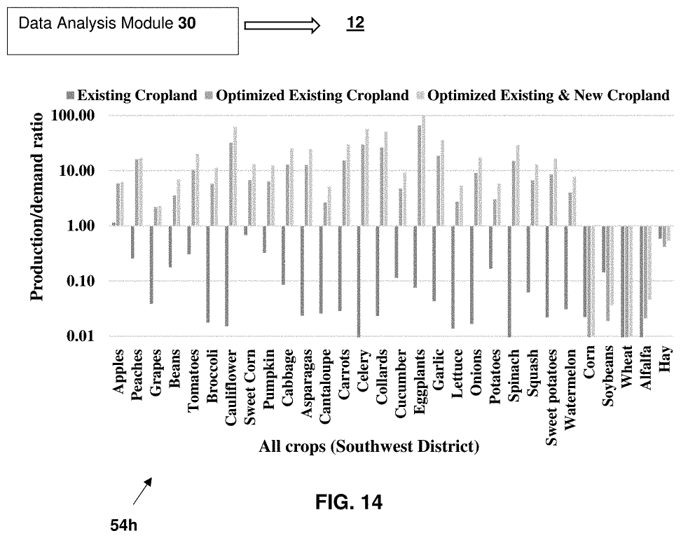

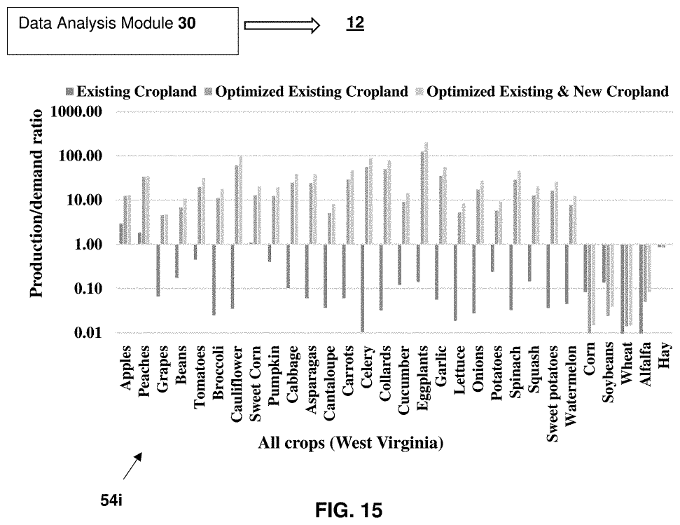

In one preferred embodiment, exemplary software may be utilized to execute MO planning to evaluate land slope, crop diversity, crop yield and sale price for the purpose of determining which existing and expandable arable lands sites are most ideal for agricultural development. An objective addressed by such embodiment is increased food production for a particular region. Referring now to FIGS. 3-15, MO programming data was obtained for the State of West Virginia in accordance with an exemplary embodiment 10 of the present invention.

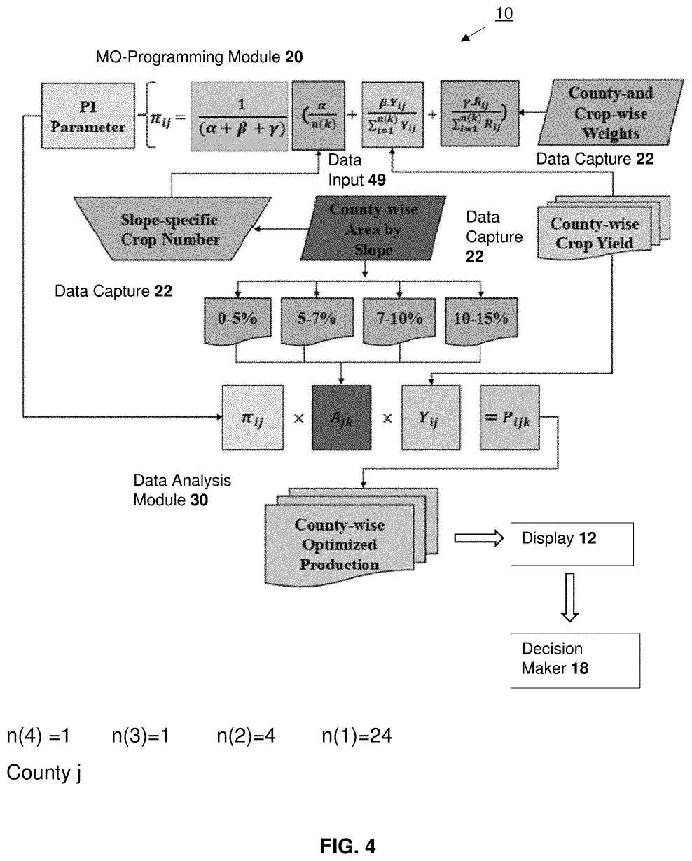

Referring specifically to FIGS. 3-4, exemplary MO programming 48 may include equations (3)-(7). With respect to equation (5), the α, β, and γ symbols represent the weighting factors. With respect to equations (5) and (6), the first quotient in the parenthesis is crop diversity, the second quotient is crop yield, and the third quotient is revenue. The term n(k) is the number of different types of crops that are suitable for a given slope range k. Crop type is denoted by i and county is denoted by j. With respect to equations (4), (5) and (7), the π value (which in this particular embodiment represents resource allocation scenario) may be multiplied by the area of arable land in county j falling into slope category k (Aⱼₖ) and then multiplied by the overall crop yield for county j (Yᵢⱼ) to yield a production scenario (Pᵢⱼₖ) (an alternative form of MOPF result with respect to aforementioned π scores) which may demonstrate the favorability/desirability magnitude of planting at different potential agricultural sites (e.g., in West Virginia, land slope is a major limiting factor with respect to agricultural activity). By having a plurality of MOPF calculated values illustrated, for example, in graphs or raster/vector images, a user may readily observe and identify relative geographic preferability across a particular terrestrial area. In this particular embodiment, preferability relates to maximum production scenario.

Referring now to FIGS. 3-6, accessibility 14b and arable land data 14a is shown for the state of West Virginia. In certain exemplary embodiments, arable land data 14a may provide MO programming input data, and accessibility data 14b may represent output data of an exemplary accessibility function. Raster images (e.g., 14a-b) may be displayed on a display 12 interface which may be configured 16 by a user. Accessibility may be calculated from equation (3), where A=Euclidean distance between a cell raster and a road, Aₙₒᵣₘ=normalized distance thereof, and max(A) and min(A) are minimum Euclidean distances from a road, respectively. By way of example and not limitation, accessibility data could be used in any number of MOPFs, such as when ease of transportation of an item is a major concern.

FIG. 4 further illustrates that in an exemplary embodiment 10, MO programming of the MO programming module 20 follows data capture 22 and input 49 (e.g., slope data n for each county j). MO programming calculations may be communicated to a data analysis module 30 for visual organization and display 12 of the MO data, such as for a decision maker 18.

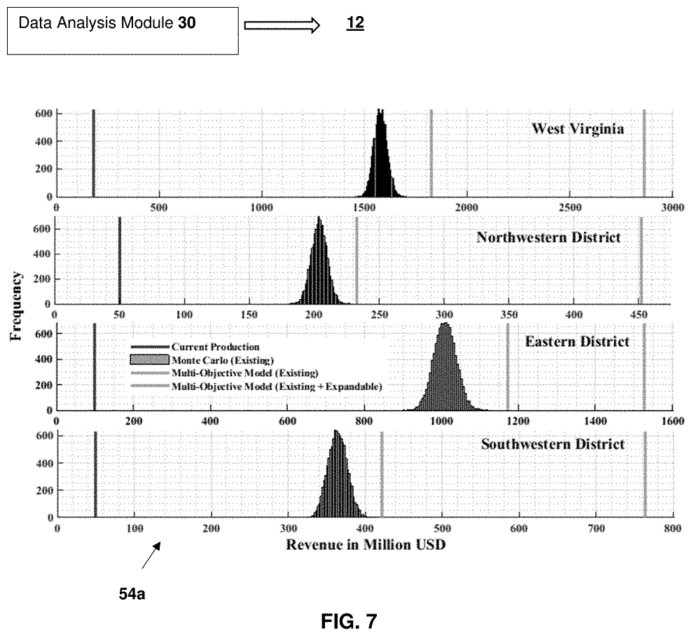

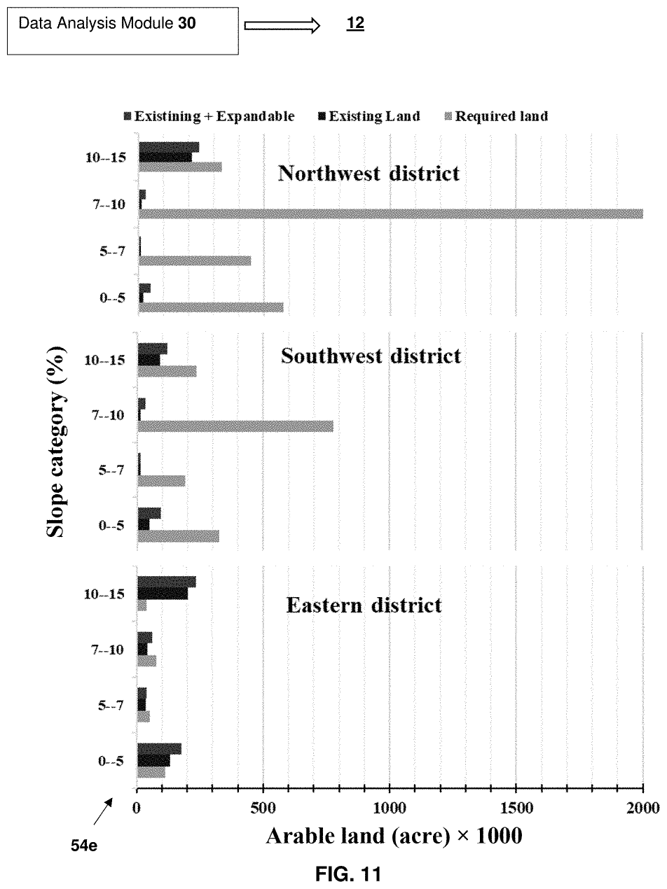

Referring now to FIGS. 7-10 and 12-15, a plurality of graphs 54a-d and 54f-i are shown on a display 12. Graphs like these may be generated from a data analysis module 30 in communication with an MO programming module. Graphs such as those shown here may be useful in guiding decision makers by assisting them in interpreting data from MO calculations. FIG. 7 illustrates that MO models may have advantages over Monte Carlo data analysis. Here, a Monte Carlo simulation algorithm was created to output randomly sampled values to the πᵢⱼₖ matrix of FIG. 3, equation (5). The results of FIG. 7 illustrate that the MOPF model of FIG. 3, equations (4)-(7) yielded outcomes having higher revenue potentials than the vast majority of Monte Carlo simulations. FIG. 11 illustrates an exemplary graph 54e on a display 12, the graph 54e representing exemplary MO programming input data in accordance with an exemplary embodiment of the present invention. The graph 54e may be rendered by an exemplary data analysis module 30.

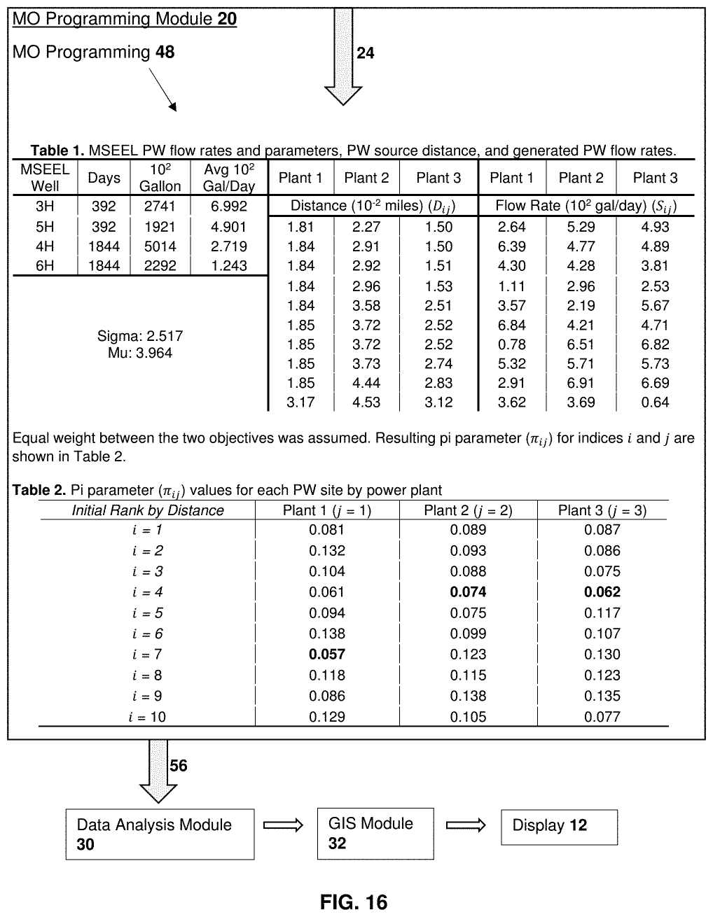

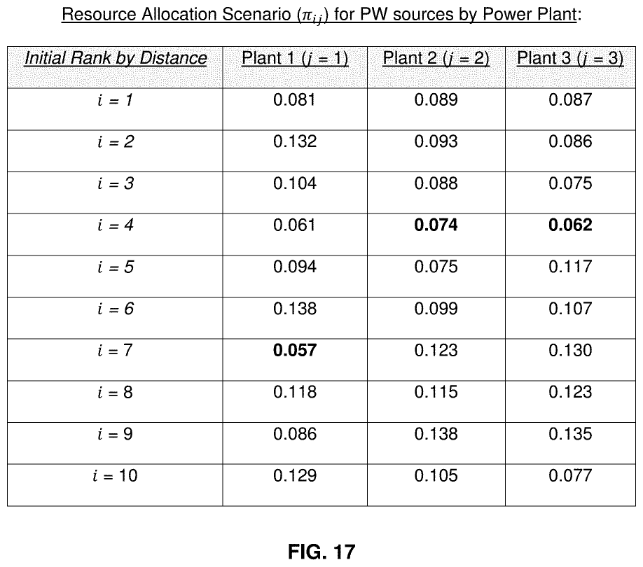

Referring now to FIGS. 16-17, in another preferred embodiment, an exemplary MO programming module 20 including exemplary MO programming 48 may be utilized to execute MO planning to evaluate the benefits of applying a co-wastewater treatment approach for managing thermoelectric power plant blowdown (“BD”) water treatment and produced water (“PW”) treatment from natural gas production in an energy producing region. FIG. 16 essentially illustrates FIG. 2 with data 24. Generally speaking, water circulated in power plants for cooling may retain high concentrations of solute (e.g., calcium and magnesium) over time, and amounts of said water may be purged at certain times to prevent and/or reduce the risk of fouling, scaling, or the like with respect to power plant equipment. Said purged water may be defined as BD or BD water. Generally speaking, PW is water obtained as a byproduct during extraction of oil and/or natural gas. By way of example and not limitation, combining PW and BD may promote the capacity of the waters to be reused in various power industry operations. It will be apparent to one of ordinary skill in the art that PW and BD may be combined or utilized together in any number of different beneficial water treatment applications (referred to herein as “co-treatment” or “co-BD-PW wastewater treatment”). Co-treatment may reduce environmental costs, energy costs, chemical costs, financial costs, some combination thereof, or the like to the power industry, public and natural environment with respect to BD and PW management. In certain exemplary embodiments, MOPFs may be executed according to software instructions of one or more processors in order to determine favorability of different PW sites for combining PW thereof with BD of a nearby powerplant for water co-treatment.

Referring now to FIGS. 2 and 16-17, data 24 relating to distance from a PW source to a thermoelectric powerplant may be represented as Metric A, and PW flow rate at each PW source may be represented as Metric B. The j vector may denote each of three thermoelectric power plants (e.g., for a first power plant, j=1; e.g., for a second power plant, j=2; e.g., for a third power plant, j=3), and the i vector may denote a rank by distance of each PW source from the thermoelectric powerplant (e.g., for a closest PW source, i=1; e.g., for a farthest of ten PW sources, i=10). In the aforementioned embodiment, an exemplary MOPF executed according to software instructions of one or more processors may include the following:

$${π}_{ij} = \frac{1}{{α}_{ij} + {β}_{ij} + {γ}_{ij} + …} \cdot ( \frac{{α}_{ij} \cdot {A}_{ij}}{{\sum }_{i = 1}^{n} {A}_{ij}} + \frac{{β}_{ij} \cdot {B}_{ij}}{{\sum }_{i = 1}^{n} {B}_{ij}} + \frac{{γ}_{ij} \cdot {C}_{ij}}{{\sum }_{i = 1}^{n} {C}_{ij}} + … )$$

Here, the α, β, and γ symbols may represent the weighting factors. It will be apparent to one of ordinary skill in the art that any number of different considerations and/or determinations may be accounted for in assigning weight to a particular dataset. For illustrative purposes, equal weight is assigned to datasets in the FIGS. 16-17 embodiment. In this particular embodiment, the datasets are produced water source distance (A) (ranked by i) from a thermoelectric power plant (represented by j), and produced water flow rate (B) at each produced water source. (C) is a hypothetical third metric. In this particular embodiment, (C) is not considered in π score calculations, but it will be apparent to one of ordinary skill in the art that any number of different additional factors may be considered for valuing and comparing PW sources. Said additional factors may be incorporated into an exemplary MOPF as (C) or a subsequent metric.

The π score may represent a resource allocation scenario (πᵢⱼ, i=1 . . . n) for each PW source, where the sum of all π scores for a particular power plant equals 1. Thus, the resource allocation scenario may represent a proportion π, which may be multiplied by 100 to provide a percentage. By way of example and not limitation, the π score may be multiplied by 100 to: provide a percentage of a certain resource to be allocated to a particular location; represent a favorability or desirability percentage of a particular location with respect to other locations; represent a percentage need of a certain resource at a particular location; some combination thereof, or the like. It will be apparent to one of ordinary skill in the art that any number of different resources may be distributed or otherwise organized according to exemplary determination of MOPF results.

In the particular embodiment shown, the π score represents the desirability of each potential PW site choice. Here, the lower the π score, the more desirable the PW site for incorporating said site into a water co-treatment approach. Generally speaking, lower values in the scenario matrix (represented by FIG. 17) correspond to PW sources with more manageable flow rates closer to a given power plant, which may be desirable for co-treatment. Bolded values in FIG. 17 represent a PW site having a lowest π score for each power plant. The π scores may be communicated to a data analysis module 30 and/or a GIS module 32 for visual organization with respect to a display 12. For example, by way of illustration and not limitation, PW sites may be ranked from most favorable to least favorable (or vice versa), graphed, and/or assigned a visual raster value in a geospatial rendering to make it clear which sites are the most favorable for incorporating into water co-treatment.

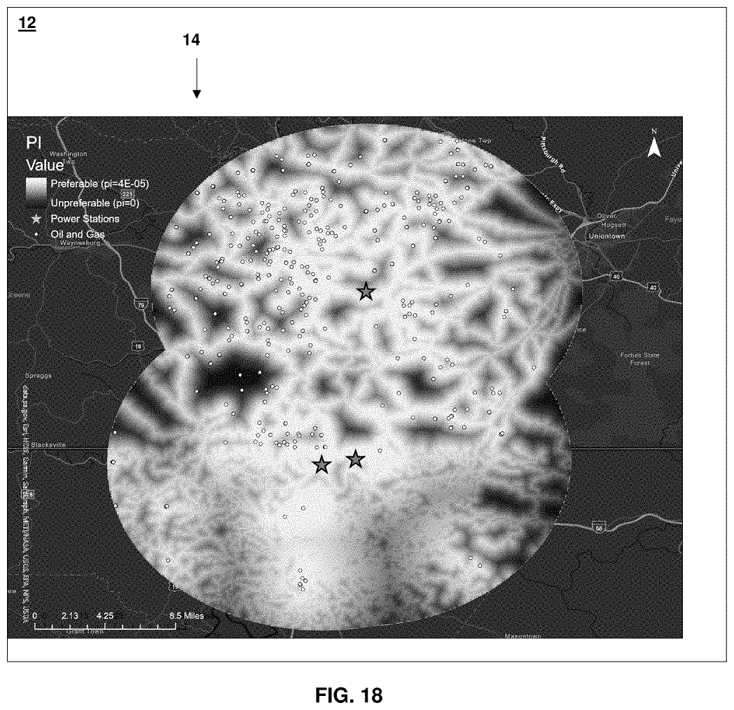

Referring now to FIG. 18, in accordance with another exemplary embodiment for valuing and comparing PW sources, an MOPF model is used to identify preferable land parcels surrounding power plants and oil and gas production wells for implementing co-BD-PW wastewater treatment technology (illustrated by image 14 on display 12—this particular non-limiting illustration represents land near Morgantown, W. Va.). The MOPF may be executed according to software instructions of one or more processors. The MOPF may be consistent with the framework and parameters of the FIG. 2 embodiment. Variables incorporated into the exemplary MOPF of FIG. 18 may be distance of each land parcel (illustrated as a raster cell) to a roadway (Metric A), distance of each land parcel from a power plant (Metric B), and distance of each land parcel from each PW site (Metric C).

Specifically, the i vector may represent a set of distances between each land parcel and PW sources. The j vector may represent a set of distances between each land parcel and thermoelectric power plants (non-limiting example sources of BD water). The aforementioned distances may be Euclidean distances, although it will be apparent to one of ordinary skill in the art that such is not required. The aforementioned distances may alternatively be driving distances, driving times, or the like in other embodiments. Preferably, here, the aforementioned distances represent accessibility of PW and BD water with respect to various land parcels. Calculated π values may be communicated to a data analysis module and/or a GIS module for visual organization with respect to a display 12. Here, the raster illustrates π values of land parcels across the region examined. The more preferable parcels are indicated by lighter shading in FIG. 18. Generally speaking, in the embodiment shown, lighter shading corresponds to parcels closest to a roadway, power plant and PW source. Each of these distances may have an impact on the environmental, energy, chemical, financial, some combination thereof, or the like costs of co-treatment. The data analysis module and/or GIS module may assign indicators (e.g., in FIG. 18, a dot indicator for an oil and/or gas well; a star indicator for a power station) to relevant geospatial parameters. It will be apparent to one of ordinary skill in the art that any number of different indicators may be employed to represent any number of different parameters in a geospatial rendering without departing from the scope of the present invention. By way of example and not limitation, the plot 14 on display 12 may be beneficial for assisting decision makers in deciding where to implement transportation routes in a co-treatment approach, deciding which subset(s) of PW sources to use in co-treatment, some combination thereof, or the like.

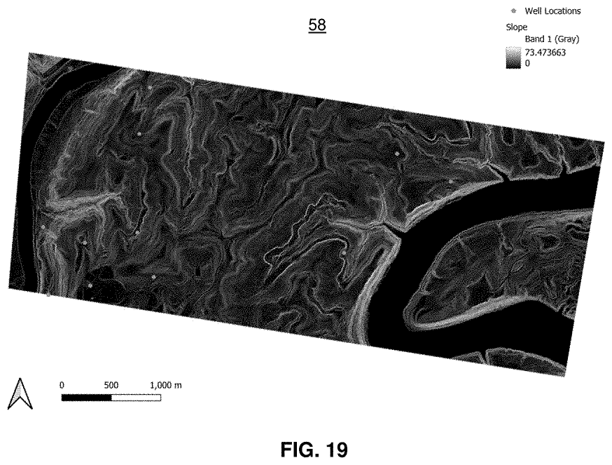

Referring now to FIGS. 3 and 19-20, MO planning may be performed according to exemplary MO Programming 48 to determine suitability of land for implementing co-treatment based on consideration of land slope and distance to the nearest oil/gas well (e.g., Well Locations in FIG. 19). With respect to equations (1)-(2), the first objective dataset (Oᵢ^{[1]}) may be land slope for each of various parcels of land in a particular region (e.g., region of West Virginia illustrated in FIG. 19). The second objective dataset (Oᵢ^{[2]}) may be Euclidean distance from any given land parcel to the nearest oil/gas well. By way of example and not limitation, land slope data and oil/gas well location data may be represented in and/or obtained from a raster plot (e.g., plot 58 of FIG. 19) and vector file data thereof. By way of example and not limitation, plots (e.g., 58) may be created using publicly available data and GIS technology. In FIG. 19, darker shading represents flatter terrain. It will be apparent to one of ordinary skill in the art that there may be any number of different methods available for organizing and illustrating data utilized in an exemplary MOPF without departing from the scope of the present invention.

In this particular embodiment, desirable locations for co-treatment implementation may correspond to close proximity to a PW source (e.g., oil/gas well in FIG. 19) and level terrain. With respect to the weighting multipliers (ω^{[θ]}), an assumption may be made that each well contributes an equal amount of PW, and proximity to PW and terrain slope are equally important. Based on said assumption, in this particular embodiment, Euclidean distance is not weighted by well, and the weighting multipliers (ω^{[θ]}) are each set to 1 to represent equal importance between each metric.

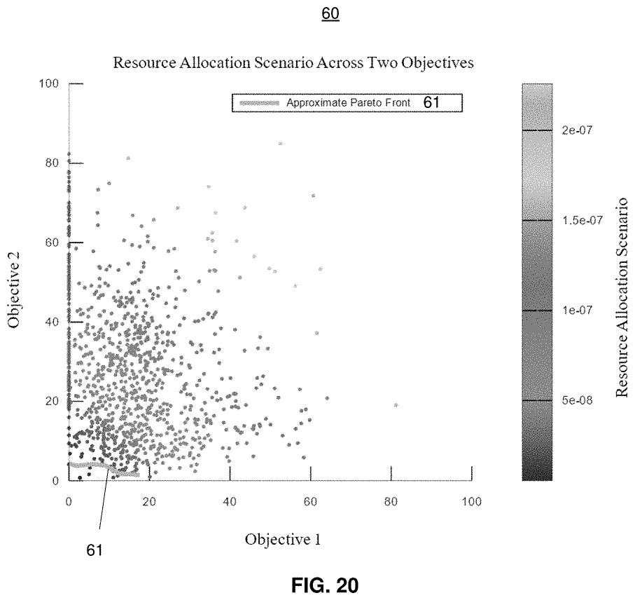

Referring specifically to FIGS. 3 and 20, for each land parcel, values thereof for both terrain slope and distance to PW source may be represented as a percentage of the maximum terrain slope or the maximum distance to an oil/gas well. Thus, the higher the percentage, the steeper the terrain, or the larger the distance to the nearest oil/gas well. Referring to equation (1), values for each land parcel (of index i) may be plotted in the in the Oᵢ^{[1]}, Oᵢ^{[2]} plane (Resource Allocation Scenario Across Two Objectives 60 in FIG. 20) by representing each land parcel in vector format according to the aforementioned percentages as opposed to representing each land parcel in raster format.

In FIG. 20, the coordinates for each point (corresponding to each relevant land parcel) represent terrain slope (x-coordinate) and PW proximity (y-coordinate), each in percentage format. The PF (line of equal tradeoff between objectives) 61 is shown for Objectives 1 (x-axis) (relates to land slope) and 2 (y-axis) (relates to PW proximity). An option may be considered Pareto-optimal if the option, when plotted, is located on the PF 61. The PF 61 indicates options superior at accomplishing Oᵢ^{[1]} and Oᵢ^{[2]}. In this particular embodiment, options located on the PF 61 or in close proximity thereto correspond to land parcels having level terrain and a PW source nearby. Furthermore, in the embodiment shown, color shading is scaled to correspond to π score. Generally speaking, in the embodiment shown, π score values approximate the degree of Pareto Optimality.

Preferred options for implementing co-treatment may correspond to low π score, or high degree of estimated Pareto Optimality. Thus, in FIG. 20, the PF 61 is located in the lower left quadrant of the data. Points further away from the PF 61 (representing higher resource allocation scenario values) may represent less desirable choices for co-treatment implementation. The plot 60 of FIG. 20 may thus be beneficial for ranking various land parcels by their preferability for co-treatment implementation. One or more processors of an exemplary system for valuing and comparing choices for project development may be configured to execute software instructions for the MOPF of FIG. 20. Vector information, calculated π scores, and calculated Pareto front may be communicated from a data analysis module to a display to assist decision makers in selecting choices for implementing co-treatment. It will be apparent to one of ordinary skill in the art that embodiments herein related to co-treatment are meant to be merely illustrative, and are in no way exhaustive of the scope of the present invention.

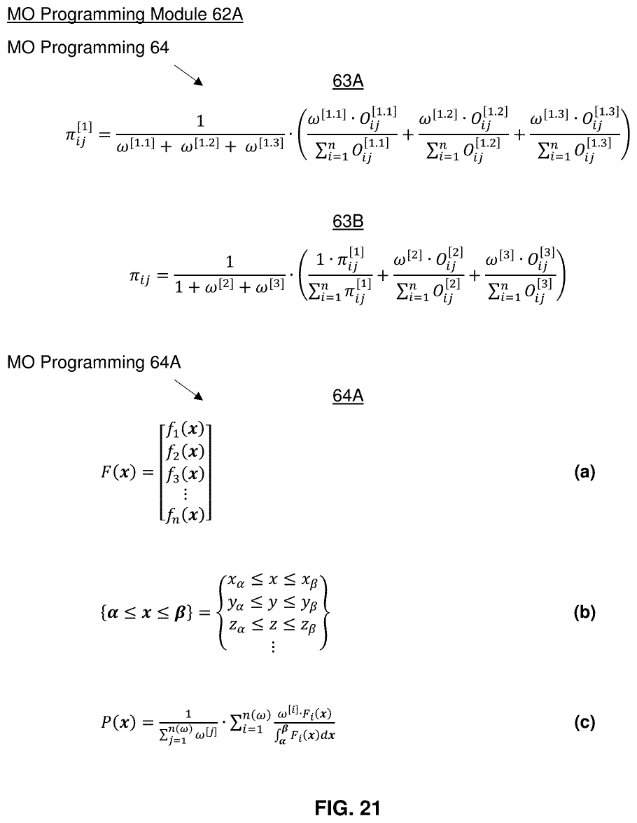

Referring now to FIG. 21, exemplary MOPFs 63A-B may be formatted to prevent emergence of a degenerate PF in a scenario requiring consideration of a high number of objectives, and may be structured to be easy to follow with respect to one of ordinary skill in the art. MOPFs 63A-B may be executed according to software instructions (e.g., MO programming 64) of an MO Programming Module (e.g., 62A) of one or more processors of a system for valuing and comparing choices for project development. MOPFs 63A-B may be beneficial when a high number of objectives require consideration, and said objectives may be categorized according to relationships therebetween. To prevent emergence of a degenerate PF, objectives may be grouped based on similarities therebetween, wherein each group may provide MOPF input for a separate sub-MOPF (e.g., 63A), for which the resultant resource allocation scenario (e.g., π score) provides an input for a primary, overarching MOPF (e.g., 63B). Thus, the sub-MOPF may provide an MOPF result that acts as an objective term for a primary, overarching MOPF.

In one particular embodiment where five objectives Oᵢⱼ^{[1,1]}, Oᵢⱼ^{[1,2]}, Oᵢⱼ^{[1,3]}, Oᵢⱼ^{[2]}, and Oᵢⱼ^{[3]} are considered in two dimensions (i,j), the objectives Oᵢⱼ^{[1,1]}, Oᵢⱼ^{[1,2]}, Oᵢⱼ^{[1,3]} are related to one another. The five objectives may correspond to weighting multipliers ω^{[1,1]}, ω^{[1,2]}, ω^{[1,3]}, ω^{[2]}, and ω^{[3]}, respectively. Here, the sub-MOPF for grouping related objectives Oᵢⱼ^{[1,1]}, Oᵢⱼ^{[1,2]}, Oᵢⱼ^{[1,3]} is MOPF 63A. This particular MOPF may permit calculation of a π score (e.g., πᵢⱼ^{[1]}) at each i and j interval for the entire group of related objectives Oᵢⱼ^{[1,1]}, Oᵢⱼ^{[1,2]}, Oᵢⱼ^{[1,3]}. Said π score (e.g., πᵢⱼ^{[1]}) may then be incorporated into the primary, overarching MOPF 63B for attaining a full model. Here, weighting multipliers ω^{[1,1]}, ω^{[1,2]}, ω^{[1,3]} for the three related objectives Oᵢⱼ^{[1,1]}, Oᵢⱼ^{[1,2]}, Oᵢⱼ^{[1,3]} are already factored in the sub-MOPF 63A, and thus do not also need factored into the primary, overarching MOPF 63B. Accordingly, in the embodiment shown, a factor of 1 is used as the weighting multiplier for the πᵢⱼ^{[1]} term.

In the embodiment shown, the exemplary MOPFs 63A-B are shown partitioned along the i dimension. It will be apparent to one of ordinary skill in the art, however, that other exemplary sub-MOPFs and primary, overarching MOPFs may be partitioned along any number of different dimensions, and may further include any number of different metrics. It will also be apparent to one of ordinary skill in the art that any number of different sub-MOPFs may be incorporated into any number of different primary, overarching MOPFs without necessarily departing from the scope of the present invention. Incorporating exemplary sub-MOPFs into exemplary primary, overarching MOPFs may be beneficial for compartmentalizing objectives. Neglecting to compartmentalize objectives/metrics when many objectives/metrics are present may present a risk of a degenerate PF forming from too many metrics/objectives being considered in a single MOPF.

By way of example and not limitation, grouping objectives within an exemplary sub-MOPF model may be beneficial for valuing and comparing choices for agricultural practices. In a specific non-limiting example, a farmer may consider any number of different factors, including by way of example and not limitation, product demand, potential profits, costs of planting, what crops were grown in the last growing season (e.g., relevant to soil chemistry), and where on the property were said crops grown, land slope, water availability (e.g., irrigation access), some combination thereof, or the like when deciding which new crops to plant and where on the farmer's property to plant them. To execute an exemplary MOPF model in this non-limiting example, a sub-MOPF relevant to physical soil parameters may be incorporated, in addition to a sub-MOPF relevant to economic considerations, in addition to a sub-MOPF relevant to geographic considerations. By grouping similar considerations into appropriate sub-MOPFs before executing an overarching exemplary MOPF, the likelihood of having a degenerate Pareto Front forming may be reduced.

As a specific, non-limiting example, data related to one soil parameter (e.g., presence of beans last growing season) may closely correlate to data related to another soil parameter (e.g., high nitrogen content in the soil—beans are known to inject high levels of nitrogen into soil). By accounting for bean presence and soil nitrogen content in the same sub-MOPF, one may use weighting multipliers to ensure that nitrogen injection is not numerically accounted for twice in the overall analysis. Accidentally accounting for certain variables multiple times may result in a degenerate Pareto Front. The aforementioned example demonstrates a potential advantage of using sub-MOPFs, but it will be apparent to one of ordinary skill in the art that any number of different advantages may be provided by using sub-MOPFs.

Referring to MO programming 64A in FIG. 21, it is not required that all MOPF inputs be discrete (e.g., discrete inputs may include by way of example and not limitation, data for terrain slope, distances, flow rates, or the like). In certain exemplary embodiments, objective datasets may be provided as continuous bounded functions of one or more variables (e.g., line (a)). Here, line (a) demonstrates a set of functions F(x) available as an objective dataset. Any number of different variables may be contained within the variable vector x. The functions comprising F(x) may be integral according to boundaries shown at line (b). Here, an exemplary MOPF for non-discrete input is shown at line (c). A function within F(x) may be denoted as F(x) in the MOPF of line (c). The (x) vector may represent x, y and/or z parameters for each function within F(x). In this particular embodiment, the first function within F(x), ƒ₁(x), is denoted as F(x). In discrete input MOPFs, the number of objective datasets may be equal to the number of weighting multipliers. Similarly, here at line (c), the cardinality of F(x) corresponds to the number of functions n, and accordingly, the number of functions equals the number of weighting multipliers, n(ω)=n(F(x)). In this particular embodiment, P(x) represents a resource allocation scenario (e.g., as opposed to a π score value for a discrete input MOPF) (P(x) here is an alternative form of MOPF result).

Referring still to line (c) of MO Programming 64A, a data analysis module may be configured to assign any available α value and any available β value to the MOPF such that some or all variables within (x) may be considered. By way of example and not limitation, one or more human operators may be permitted to engage a data analysis module to assign an α value and a β value to the MOPF to determine P(x) for a specific integral bound. The α value and β value may be narrowed beyond the minimum and maximum available boundaries of (x) such that only some variables within (x) are considered. It will be apparent to one of ordinary skill in the art that narrowing MOPF range beyond an entire available range is not necessarily limited to MOPFs involving continuous bounded functions as objective datasets. Discrete input MOPFs may also be limited to consideration of only certain ranges of data points. Still referring to line (c) of MO Programming 64A, integral bounds (α, β) may be set for more than a single integral in the denominator of the MOPF shown. By way of example and not limitation, where x=(x, y), the denominator may include a single integral in x or y, or a double integral in x and y. The number of integral bounds (α, β) may be adjusted according to the number of integrals.

By way of example and not limitation, an exemplary non-discrete input MOPF model may be useful for deciding how to address pollution control. In a specific, non-limiting example, an environmental engineer may seek to address risks related to a water pollution plume. Movement of the plume may be considered to be a function of stream flow. Stream flow may be considered to be a function of hydrologic input data. An exemplary non-discrete input MOPF model may account for these functions in describing behavior of the plume and/or options for addressing risks related to the plume.

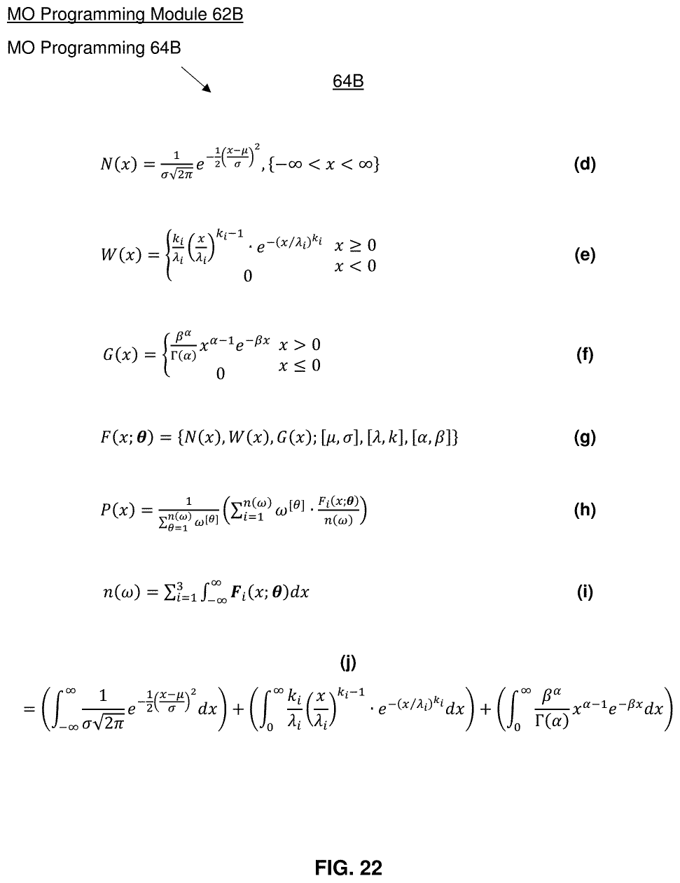

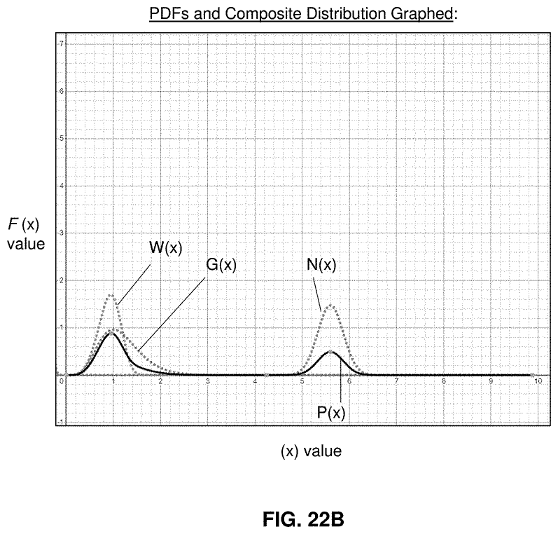

It is not necessarily required that quantities and/or precise attributes of relevant resources are known for exemplary valuing and comparing certain choices for project development. Referring to FIG. 22, an exemplary MO Programming Module 62B may be configured to execute exemplary MO Programming 64B for an exemplary composite distribution MOPF. Equations (d)-(j) of an exemplary MO Programming Module 62B may include as inputs statistical distributions related to any number of different objectives. In this particular embodiment, certain quantities and/or precise attributes of relevant resources are unknown. Said quantities/attributes may be represented by probability density functions (“PDFs”). Distributions of the PDFs may be combined into an MOPF to calculate a composite distribution, wherein the composite distribution models said quantities/attributes. An exemplary data analysis module may communicate results of the composite distribution to a display. The display of said results may assist decision makers in valuing and comparing certain choices for project development in cases when certain quantities and/or precise attributes of relevant resources have not been previously quantified.

By way of example and not limitation, referring to equations (d)-(j), a study area may include a resource having attributes described by three (N=3) independent distributions (e.g., Normal, Weibull and Gamma). Each distribution may include a particular set of parameters [μ, σ], [λ, k], [α, β]). Each distribution may be combined into a single composite distribution MOPF (e.g., equations (g)-(h)). Here, the MOPFs of equations (g)-(h) include statistical properties from the PDFs shown in equations (d)-(f). With respect to equation (g), F (x; θ) may represent a set of distribution PDFs (e.g., equations (d)-(f)) of variable x, parameterized by parameter set θ. Referring specifically to equation (h), the denominator n(w) is equal to the sum of the number of PDFs (here, the value of an integral of a PDF is 1). Thus, in the embodiment shown, n(ω)=3. Referring to equations (i)-(j), the value of each of the three integrations shown is 1, and 1+1+1=3.

Referring now to FIG. 22B, a single composite distribution (P(x)) (an alternative form of MOPF result) of equation (h) is shown compared to the PDFs (N(x); W(x); G(x)) of equations (d)-(f). Exemplary graphing may be performed by an external graphing program and/or calculator, an internal graphing calculator of the data analysis module, or the like, and the results of said graphing may be communicated to an exemplary display. It will be apparent to one of ordinary skill in the art that any number of different PDFs may be formatted into an exemplary single composite distribution MOPF without departing from the scope of the present invention.

By way of example and not limitation, a composite distribution MOPF may be useful for valuing and comparing options for land purchasing and/or development. In a specific, non-limiting example, geographic data may be represented by probability density functions, kernel density estimations, some combination thereof, or the like. A composite distribution of residential land value may be generated, for example not by way of limitation, by incorporating a probability density function representing home value as a function of radon gas concentration and a kernel density estimation of school quality into a composite distribution MOPF. It will also be apparent to those of ordinary skill in the art that MOPF outputs may be compared with any number of related datasets, probability density functions, kernel density estimations, some combination thereof, or the like to predict how MOPF output quantitatively relates to said related dataset(s)/distribution(s). As a specific, non-limiting example, if an MOPF output distribution for a city with respect to car miles driven per block, solar UV radiation, and wind activity closely mirrors an asthma distribution for that city, perhaps the MOPF is a good indicator of asthma risks, and could be useful for determining how to mitigate asthma risks for people in that city.

Referring back to FIGS. 1 and 2, data for resource partitioning may be displayed in a topographic geospatial rendering, such as a raster plot, for a particular region. Each objective dataset may represent a unique topographic parameter. The resource allocation scenario may represent a weighted combination of multiple topographic parameters. Referring back to FIG. 16, resource allocation scenario values (in this particular embodiment, π scores) may be determined purely based on known objective data. However, by way of example and not limitation, in some alternative embodiments, decision makers may seek to consider resource allocation scenarios outside the boundaries of known topographic data.

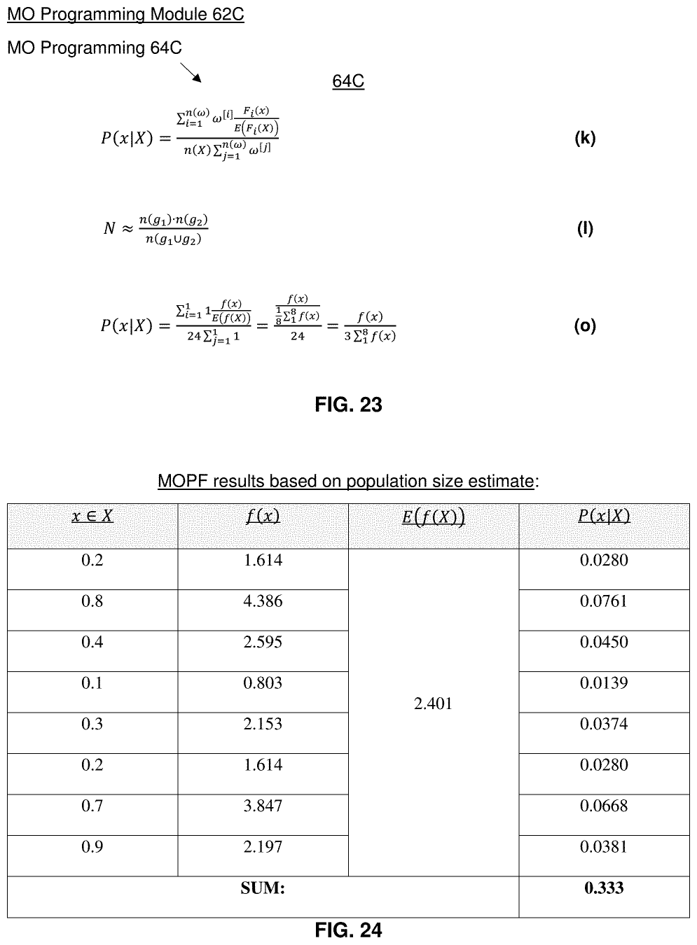

Referring now to FIG. 23, resource allocation scenario may be estimated based on statistical models in situations where certain relevant data for valuing and comparing choices for project development is known, while other relevant data thereof is unknown. An exemplary MOPF (e.g., equation (k)) may be used, by way of example and not limitation, to estimate resource allocation scenario for an estimated population size. For equation (k), an assumption may be made that the distribution of objective datasets is substantially normal, and objective datasets may be described by mean and standard deviation values for each dataset.

Here, (X) denotes a representative sample of an entire data population for each objective dataset O^{[θ]} or function Fᵢ(x). Although MO Programming 64C of an exemplary MO Programming Module 62C is shown with function terms (e.g., Fᵢ(x); ƒ(x)) in FIG. 23, it will be apparent to one of ordinary skill in the art that said function terms may be substituted with objective dataset terms when applicable without departing from the scope of the present invention. The representative sample may be used to extrapolate expected values for each objective dataset or function. Here, the equation for P(x|X) (an alternative form of MOPF result) represents an MOPF for estimating resource allocation scenario for variable x based on consideration of sample X. The term E(Fᵢ(X)) represents an expected value, the mean Fᵢ(X) value for all values of i with respect to the sample. The term n(X) may represent the sample size (cardinality) of X. The term n(X) may alternatively represent a total population size N from which samples are taken, particularly when E(Fᵢ(X)) closely represents the mean Fᵢ(X) for all values of i with respect to a total population. In this particular embodiment, the user specifies a non-infinite range along with functions that correspond to a population size.

Referring to equation (I), the Lincoln-Peterson Index (also referred to as the “capture-recapture index”) may be used to estimate a population size through random sampling of available data. In the embodiment shown, population size N is estimated for two randomly sampled groups, g₁ and g₂. The terms n(g₁) and n(g₂) refer to the respective number of group members in each group. The term n(g₁∪g₂) refers to the number of members from g₁ present in g₂. Referring back to equation (k), after population size N is estimated, P(x|X) values (here, resource allocation scenario values for an estimated population size) may be determined. Where P(x|X) values are based on estimated population size, it is possible that the sum of all P(x|X) values for all values of i in one dimension will not equal 1 since the P(x|X) values are approximations as opposed to precise proportions.

Referring now to equation (o), as a non-limiting example application of the MOPF of equation (k), the P(x|X) value indicates an estimate of suitability of each of a number of parcels of land in view of multiple objectives. In the aforementioned example, one weighting multiplier (ω=1) is included with one objective function (ƒ(x)). Here, two groups (g₁, g₂) of parcels are randomly selected (e.g., from random assignment according to any number of known techniques) from said number of parcels of land. A remote sensing satellite and/or data provided therefrom may be used to select the two groups of parcels (g₁, g₂). Where g₁ includes 8 parcels, and g₂ includes 9 parcels with 3 parcels of said 9 parcels also belonging to g₁, the Lincoln-Peterson Index for the scenario may be as follows, in accordance with exemplary equation (I):

$$N \approx \frac{8 \cdot 9}{3} = 24$$

Thus, the population size N assigned for the two groups is 24 in this particular non-limiting example. Focusing specifically on g₁, which may be considered representative of the population of 24 parcels, each parcel from g₁ may be considered or determined to have a characteristic x relating to a suitability function ƒ(x). In this particular embodiment, the suitability function is arbitrary, and is represented as a logistic sigmoid function:

$$f ( x ) = - ln ( \frac{1}{x} - 1 ) + 3$$

Sigmoid functions may be beneficial for modeling relationships between different variables in the natural world (e.g., topographic variables) since dependent natural world variables (e.g., a variable related to topography) often substantially plateau in value beyond thresholds for one or more independent natural world variables (e.g., another variable related to topography). It will be apparent to one of ordinary skill in the art, however, that it is not necessarily required that ƒ(x) represents a logistic sigmoid function.

Referring now to FIGS. 23 and 24, in the embodiment shown, values within group g₁ of sample X are assigned for characteristic (x) of each parcel, and ƒ(x) is determined for each parcel according to the above logistic sigmoid function. Here, the values assigned for characteristic (x) are merely illustrative. The mean ƒ(x) value E(Fᵢ(X)) may be calculated by taking the average of all ƒ(x) values calculated for g₁. The P(x|X) value for each parcel in g₁ may then be determined in accordance with equation (o). Referring specifically to FIG. 24, in this particular embodiment, the sample size n(X) is one third of the population size estimate (8 samples from an estimated population of 24), thus the sum of P(x|X) for g₁ is one third (0.333) of the hypothetical sum of P(x|X) for all 24 parcels, which is 1. In the aforementioned embodiment, an assumption is made that both the mean ƒ(x) value and the population size estimate accurately reflect the whole population. Where either the mean ƒ(x) value or the population size estimate do not accurately reflect the whole population, the MOPF of equation (k) may not necessarily be useful in valuing and comparing certain choices for project development.

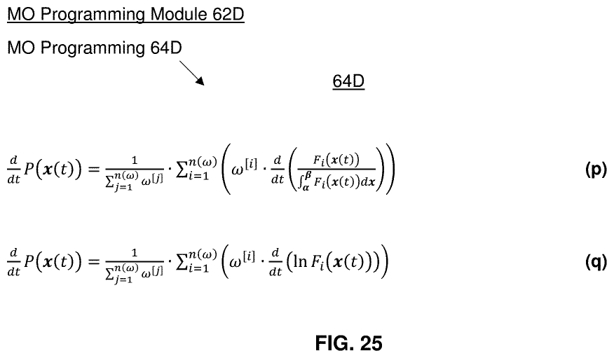

Referring now to FIG. 25, exemplary MO Programming 64D of an exemplary MO Programming Module 62D may include MOPFs (e.g., equations (p) and (d)) providing for real time modeling of resource allocation scenarios. In this particular embodiment, an assumption may be made that the sum of resource allocation scenario values across i is equal to 1. Accordingly, a present resource allocation scenario value may be subtracted from a desired future resource allocation scenario value to provide a resource allocation plan (e.g., ΔP=P_{future}−Pₚᵣₑₛₑₙₜ) In the embodiment shown, the sum of each ΔP across i is equal to 0. Each ΔP value represents the change in resource allocation scenario needed for a particular desired future resource allocation scenario value to be achieved while having the sum of each ΔP across i equal 0. Values for Pₚᵣₑₛₑₙₜ present may be obtained from a current analysis of relevant objective data.

Referring now to FIGS. 21 and 25, when the variables (x) which determine P_{future} and Pₚᵣₑₛₑₙₜ are functions of time, a real time model of P(x) (an alternative form of MOPF result) may be achieved by taking the derivative with respect to time of the MOPF of equation (c). The resultant derivative function is shown in equation (p). It will be apparent to one of ordinary skill in the art that the function terms in equation (c) may be replaced with objective dataset terms without departing from the scope of the present invention.

It will be apparent to one of ordinary skill in the art that real time modeling of resource allocation scenarios may demonstrate any number of different benefits for valuing and comparing certain choices for project development. By way of example and not limitation, a farmer may compare a current π score for a certain parcel of crops with a hypothetical ideal π score to understand possible changes necessary to improve on the π score for that parcel, and may monitor π score over time to evaluate whether changes being made are helpful or not. Since current π score values of an exemplary MOPF and hypothetical ideal π score values of an exemplary MOPF preferably both sum to 1, current π scores may be subtracted from hypothetical ideal π scores, the overall difference preferably being 0. Plants for parcels having negative difference values may be removed and added to parcels having positive difference values.

Referring again specifically to FIG. 25, the derivative function shown in equation (p) may be simplified in accordance with the known chain rule for derivatives. A simplification of equation (p) in accordance with the chain rule for derivatives is shown in equation (q). An assumption may be made that Fᵢ(x(t))>0 for all values of interest. In addition, an exemplary MOPF may be partially derived with respect to any variable within x and time (e.g.,

$$\frac{\partial x ( u )}{\partial t} P ( x ) )$$

(where “u” relates to an arbitrary, hypothetical additional variable), or by any two variables within x

$$( e . g . , \frac{\partial x ( u )}{\partial x ( v )} P ( x ) )$$

(where “u” and “v” relate to arbitrary, hypothetical variables).

The FIG. 25 embodiment may be beneficial for both selecting where to redistribute resources and how much resources to redistribute thereto (e.g., according to analysis of ΔP values), and for modeling achievement of desired resource allocation scenarios in real time (e.g., according to analysis of real-time

$$( \frac{dP}{dt} )$$

values). An exemplary MO Programming Module 62D may be configured with software executable instructions for calculating ΔP values and

$$( \frac{dP}{dt} )$$

values. The aforementioned values may be communicated to a data analysis module and organized into one or more displays, including by way of example and not limitation, a dynamic raster graphic display of

$$( \frac{dP}{dt} )$$

values for real time monitoring of changes in resource allocation scenarios with respect to several choices for project development. It will be apparent to one of ordinary skill in the art that exemplary MOPFs may be implemented according to any number of different software executable instruction formats without departing from the scope of the present invention.

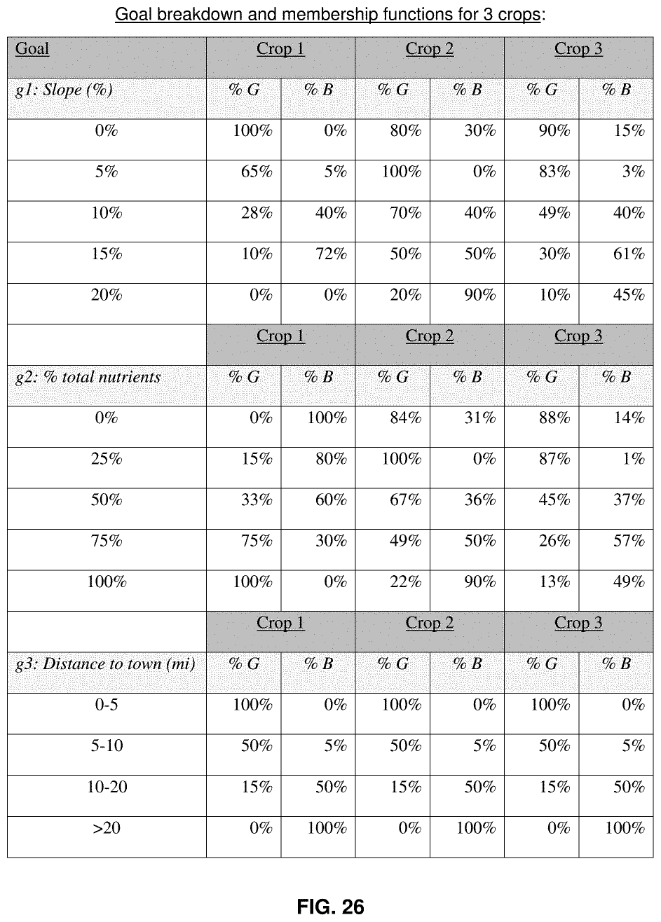

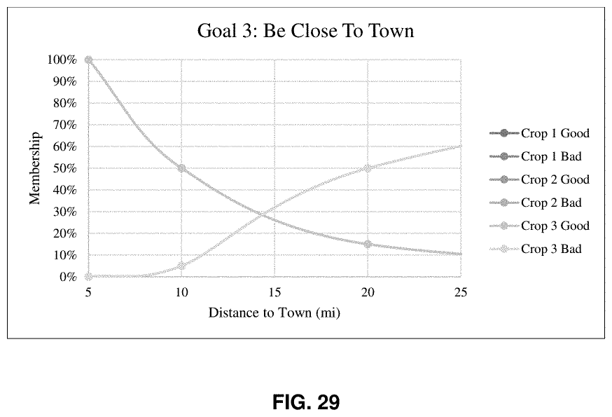

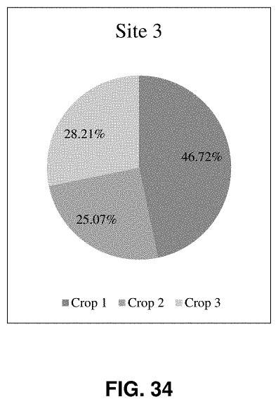

Referring now to FIGS. 26-34, in addition to representing favorability/desirability magnitude of a choice with respect to project goals, MOPF output may also represent unfavourability of a choice with respect to project goals. The MO planning framework shown in these figures may permit two numeric values to be expressed for each project choice, a favorability/suitability percentage (“% Good” or “% G”), and an unfavourability/unsuitability percentage (“% Bad” or “% B”). Referring specifically to FIG. 26, as a non-limiting example of an exemplary embodiment, a farmer may seek to plant 3 different crops on three different plots of land. Relevant variable attributes with respect to the three plots of land may include ground slope, percent of total nutrients available for each crop, and distance of the plot of land to a nearest town. Accordingly, three goals (g1: slope) (g2: total nutrients) (g3: distance to town) are shown, wherein g1 may be best achieved by a certain land slope for each crop, g2 may be best achieved by a certain soil nutrient content for each crop, and g3 may be best achieved by a certain proximity to a town for each crop. Each attribute may have variable significance to each crop. By way of example and not limitation, it may be more important for crop 1 to be closer to the nearest town because perhaps crop 1 does not travel well. As another non-limiting example, it may be less important for crop 1 to have a high nutrient supply, because perhaps crop 1 is relatively resilient.

FIG. 26 specifically illustrates favorability versus unfavourability percentage breakdown of each goal with respect to each crop for several factor intervals. The percentages shown in this figure are merely illustrative, and are in no way meant to be exhaustive. It will be apparent to one of ordinary skill in the art that there may be any number of different methods available to assign percentages (also referred to herein as “membership values”) for various goals with respect to various aspects of interest (e.g., in this embodiment, aspects of interest includes three different crops). It will also be apparent to one of ordinary skill in the art that information about each relevant plot of land may be obtained according to any number of different methods without departing from the scope of the present invention. By way of example and not limitation, information about each plot of land relevant to the goals may be obtained from measurements of soil moisture content, measurements of soil organic matter content, survey data, some combination thereof, or the like.

In the embodiment shown, g1 is expressed in various percentage intervals, where each percentage interval corresponds to a range of land slopes (e.g., 0% denotes substantially level land; 20% denotes substantially steep land; and although not shown, 100% may denote a cliff face). Here, g1 is also expressed in various percentage intervals, where each percentage interval corresponds to a range of nutrient levels (e.g., 0% denotes substantially nutrient depleted soil; 100% denotes substantially nutrient saturated soil). Here, g3 is expressed in various distance intervals, where each distance interval is a range of distances measured in miles. The closer % G is to 100%, and the farther % B is from 100%, the more desirable the particular interval may be for the particular crop. Ideally, a plot of land selected for growing the particular crop would exhibit a high % G and low % G for slope, total nutrients, and distance to town.

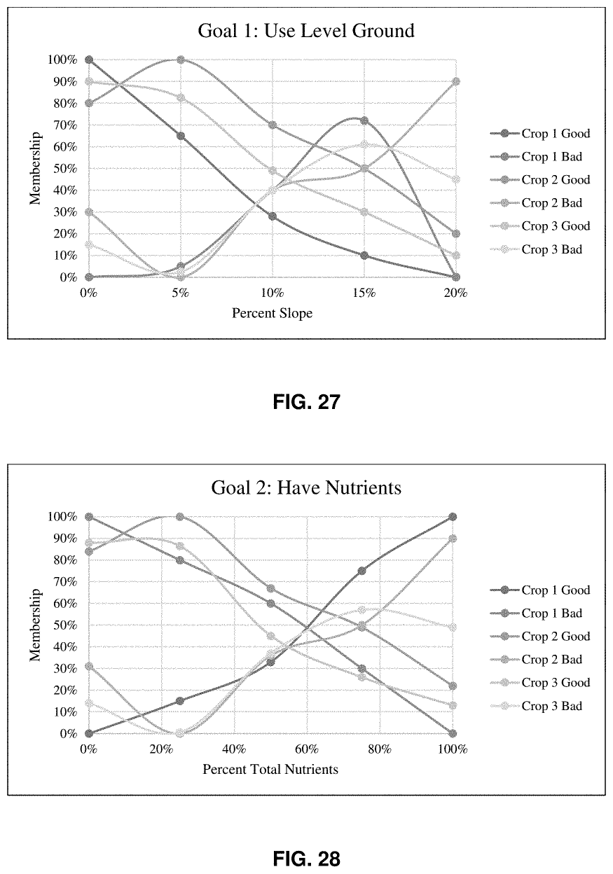

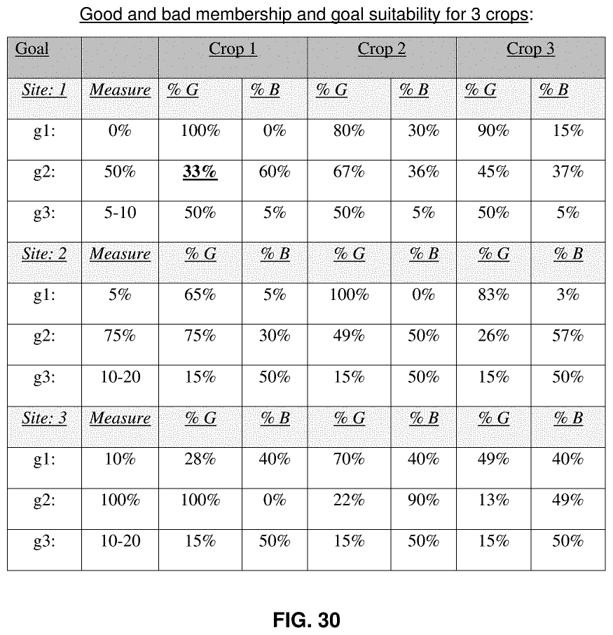

Referring now to FIGS. 27-29, the % G and % B distributions for each crop are shown. The graphs of FIGS. 27-29 may, by way of example and not limitation, be organized according to software instructions of a data analysis module, and displayed on one or more displays to assist one or more decision makers in visualizing attribute levels beneficial and/or detrimental to each crop. Referring to FIG. 30, a favorability versus unfavourability percentage breakdown of each goal with respect to each site is shown. The percentages shown in this figure are merely illustrative, and are in no way meant to be exhaustive. It will be apparent to one of ordinary skill in the art that there may be any number of different methods available to assign percentages for various goals with respect to various aspects of interest (e.g., in this embodiment, aspects of interest includes three different crops). It will also be apparent to one of ordinary skill in the art that information about each relevant plot of land (sites 1-3) may be obtained according to any number of different methods without departing from the scope of the present invention. Here, the “Measure” column for g1 indicates the slope interval for the site, for g2 indicates the nutrient content interval for the site, and for g3 indicates the distance interval for the site.

As another non-limiting example, % G, % B, and the like (e.g., a measure somewhere between G and B) data may be represented by membership functions created from survey data. Said membership functions may be used as input functions for any number of different MOPF models. By way of example and not limitation, in an exemplary overarching MOPF, a sub-MOPF representing a % G membership function may be combined with a sub-MOPF representing % B membership function. As another non-limiting example, MOPF values may represent a combining of % G, % B, and the like values. It will be apparent to one of ordinary skill in the art that any number of different methods of incorporating % G, % B and the like data and/or functions into an exemplary MOPF may be employed without necessarily departing from the scope of the present invention. It will also be apparent to one of ordinary skill in the art that computing of % G, % B and the like data and/or functions may occur in real time over an extended amount of time.

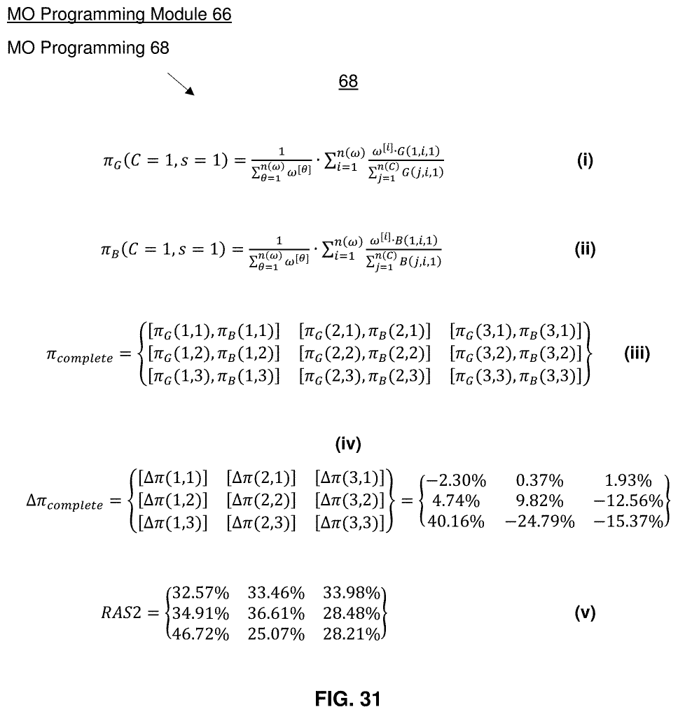

Referring now to FIG. 31, exemplary MO Programming 68 is shown for an exemplary MO Programming Module 66. In this particular embodiment, the MO Programming 68 includes an MOPF (equation (i)) which may be used for % G values relating each crop to each analysis goal, and another MOPF (equation (ii)) which may be used for % B values relating each crop to each analysis goal. It will be apparent to one of ordinary skill in the art that the exemplary MOPFs shown are not limited to relating crop choices to analysis goals, and the MOPFs may be useful in any number of different project development choice applications. Referring now to FIGS. 26-34, with respect to the % G MOPF of equation (i), with respect to crop 1, and with respect to site 1, a π score (π_{G}(C=1, s=1)) may be calculated according to the good membership table/curve values for each goal. Good membership values may be defined by G(C, g, s), where C is the specific crop (1, 2, or 3), g is the specific goal (1, 2, or 3), and s is the specific site (1, 2, or 3). By way of example and not limitation, G(1,2,1) relates the value bolded and underlined in FIG. 30, which is 33%.

Now referring to the % B MOPF of equation (ii), bad membership values may be defined by B(C,g,s). By way of example and not limitation, the π score (π_{B}(C=1, s=1)) shown in FIG. 31 relates specifically to crop 1 and site 1. Referring to both equations (i) and (ii), n(C) refers to the total number of crops considered (e.g., 3 in this particular example). The term ω^{[i]} refers to a weighting multiplier for a specific goal. In this particular embodiment, a weighting multiplier is applied for each goal. Thus, in this particular embodiment, the weighting multiplier reflects the relative importance of each land slope, nutrient supply, and distance to the nearest town. Referring now specifically to FIG. 31, for illustrative purposes only, in the embodiment shown, weighting multipliers are set as ω={30%, 60%, 10%} corresponding to g1, g2, and g3, respectively. The two MOPFs of equations (i) and (ii) may be combined into a complete MOPF model reflecting an ideal scenario (e.g., equation (iii)).

Referring to equation (iii), each π_{B} is subtracted from each π_{G} with respect to each of the 3 crops and 3 corresponding sites. The result of said subtraction for this particular non-limiting example is shown at equation (iv). Furthermore, in this non-limiting example, the sum of Δπ_{complete} for each row (for all sites) is equal to 0. The following percent change equation may be used to calculate an ideal proportion/resource allocation scenario of each crop to be used at each site:

$$C \% = \frac{RAS 2 - RAS 1}{RAS 1}$$

In the aforementioned equation, C % represents a percent change to achieve an ideal proportion/resource allocation scenario. RAS1 represents a current resource allocation scenario, and RAS2 represents an idea resource allocation scenario. In the embodiment of FIGS. 26-31, Δπ_{complete} represents values of C %.

An assumption may be made that equal distribution is the default state of an MOPF. Based on said assumption, RAS1 may be considered

$$\frac{1}{n ( C )}$$

(in this example, ⅓ since there are three crops) for all values contained within Δπ_{complete}. RAS2 may be solved for by substituting Δπ_{complete} for C %, and by substituting

$$\frac{1}{n ( C )}$$

for RAS1. An equation for RAS2 may be as follows:

$$RAS 2 = \frac{1}{n ( C )} ( Δ {π}_{complete} + 1 )$$

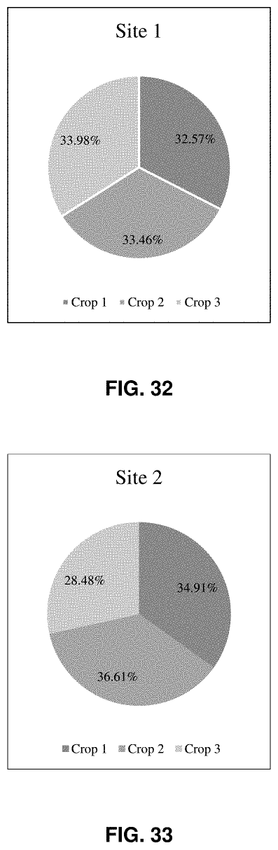

By plugging in each Δπ_{complete} value from line (iv) into the aforementioned equation, RAS2 values in line (v) may be determined. Each row in line (v) corresponds to each site of sites 1-3. Percentages for each site add to 100% (e.g., indicating that 100% of the land at each site is used for the most suitable crops). The aforementioned percentages are graphed in FIGS. 32-34. These graphs may be organized by an exemplary data analysis module and communicated to an exemplary display to assist one or more decision makers in selecting and allocating resources.

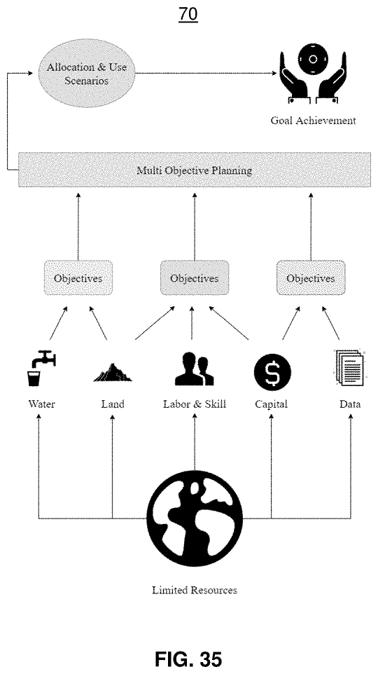

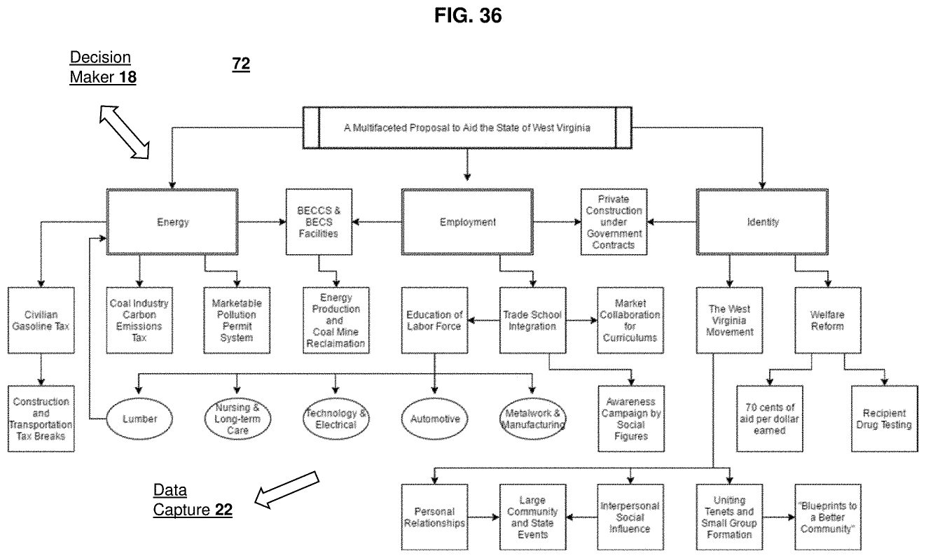

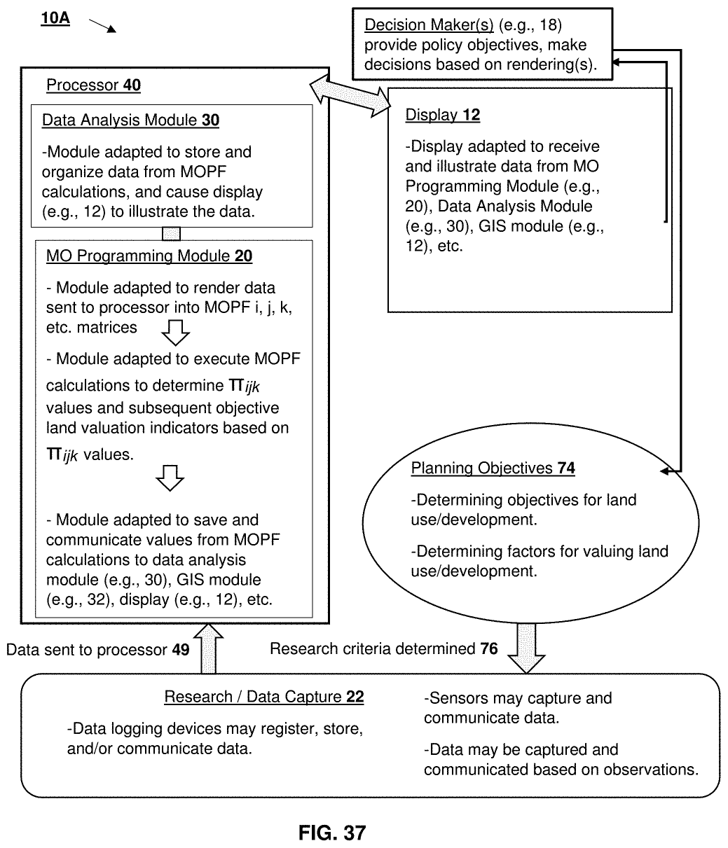

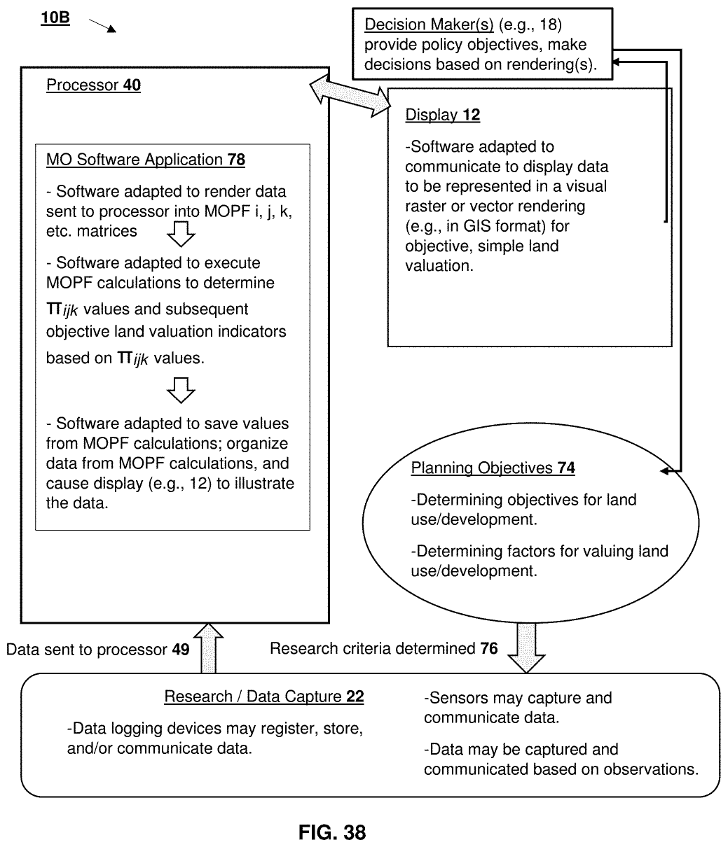

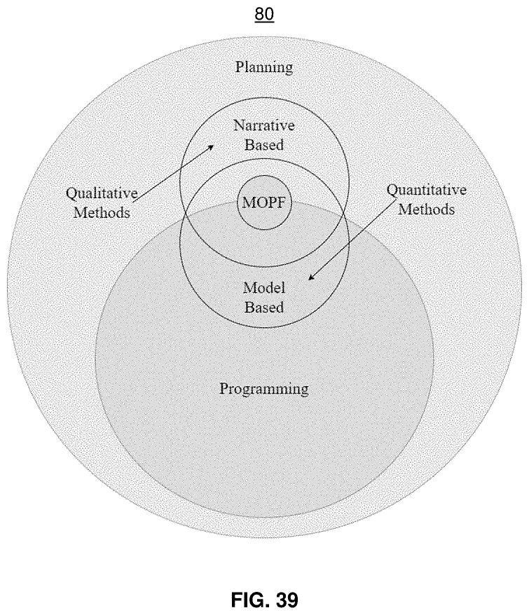

Referring now to FIG. 35, exemplary MO planning 70 at a high level is illustrated. Referring now to FIG. 36, a myriad of policy objectives and concerns 58 influencing research/data capture 22 and inevitable decision making 18 are shown. Referring now to FIGS. 37-38, exemplary embodiments of the present invention 10A-B are shown where a processor 40 is in communication with a display 12 viewable by decision maker(s) 18. Data may be sent 49 to the processor 40 after research/data capture 22 takes place. Planning objectives 74 may dictate the research criteria 76 that drives research/data capture 22. Referring to FIG. 37, the processor may comprise an exemplary MO programming module 20 and data analysis module 30. Referring to FIG. 38, the processor may comprise an MO Software Application 78 that provides exemplary MO programming and other data analysis capabilities. The MO Software Application 78 may be a downloadable software application configured to communicate to the processor 40 instructions for executing one or more MOPFs, and further configured to communicate to the processor 40 instructions for organizing MOPF results for each of multiple project choices into a digital rendering (e.g., at display 12). A downloadable software application (e.g., 78) may yet further be configured to instruct the processor 40 to register objective data (e.g., data sent to processor 49) to be considered by the MOPF.

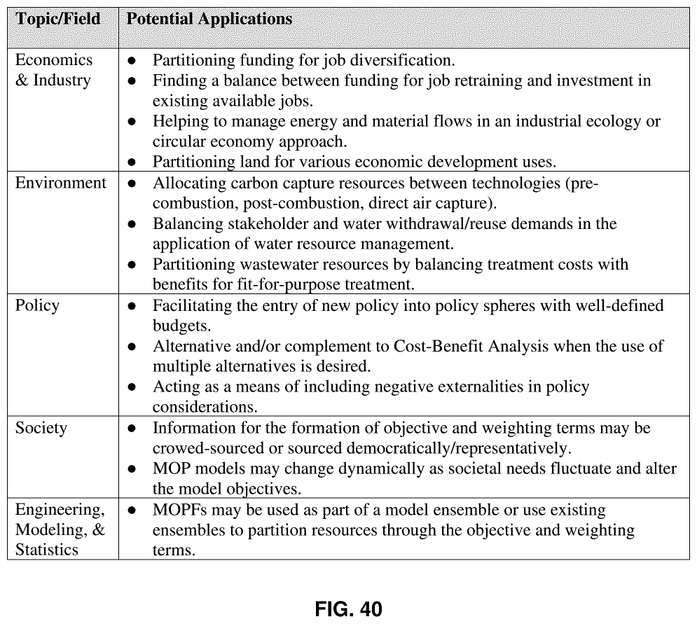

Referring to FIG. 39, exemplary logic 80 related to an MOPF at a high level is illustrated. Exemplary MO Planning may include both qualitative (narrative-based) and quantitative (model-based) considerations. Qualitative considerations may include identification and characterization of a problem, data collection, listing of options, option selection, and the like. Quantitative considerations may include the data itself, MO Programming, visual organization of MOPF output, and the like. Options may be ranked by a non-qualitative, numeric-based model for decision maker consideration. Referring to FIG. 40, potential applications of exemplary MO planning is shown. It will be apparent to one of ordinary skill in the art that the list of FIG. 40 is merely illustrative, and is in no way exhaustive of the scope of the present invention.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices may be general purpose computers or specialized computing devices. The electronic devices may comprise personal computers, smartphone, tablets, databases, servers, or the like. The electronic connections and transmissions described herein may be accomplished by wired or wireless means. The computerized hardware, software, components, systems, steps, methods, and/or processes described herein may serve to improve the speed of the computerized hardware, software, systems, steps, methods, and/or processes described herein.

What is claimed is:

1. A system for valuing and comparing certain choices for project development, the system comprising:
a processor, configured with instructions to execute an MOPF, the MOPF including one or more objective terms;
a display;
wherein the MOPF is adapted to provide an MOPF result for a project choice;
wherein the MOPF comprises a first sum including one or more objective terms divided by a second sum including one or more weighting multipliers, each weighting multiplier associated with one objective term;
wherein the processor is adapted to communicate the MOPF result to the display; and
wherein the processor is configured to organize MOPF results for each of multiple project choices into a digital rendering.

2. The system of claim 1, wherein:
the processor is further configured to organize MOPF results for each of multiple project choices into a geospatial rendering; and
each MOPF result corresponds to favorability magnitude of the project choice.

3. The system of claim 1, further comprising:
a downloadable software application, configured to communicate to the processor instructions for executing the MOPF, and further configured to communicate to the processor instructions for organizing MOPF results for each of multiple project choices into the digital rendering.

4. The system of claim 1, wherein:
the processor is further configured with instructions to execute a sub-MOPF, wherein the sub-MOPF permits related objectives to be organized into an MOPF result providing an input to the MOPF of claim 1.

5. The system of claim 1, wherein the processor is configured to register objective data across one or more dimensions to be considered by the MOPF.

6. The system of claim 2, wherein the geospatial rendering is at least one selected from the group of a raster plot and a vector plot.

7. The system of claim 1, wherein said project is a multi-parcel land development project.

8. The system of claim 1, wherein a number of planning objectives determine a function to be included in an objective term of the MOPF.

9. The system of claim 1, further comprising:
a derivative MOPF, wherein the derivative MOPF includes a derivative of one or more terms from the MOPF of claim 1.

10. The system of claim 1, wherein at least one MOPF result is a percentage value.

11. A method for valuing and comparing certain choices for project development, the method comprising:
providing a processor, and configuring the processor with instructions to execute an MOPF, the MOPF including one or more objective terms;
providing a display;
adapting the MOPF to provide an MOPF result for a project choice;
configuring the MOPF to comprise a first sum including one or more objective terms divided by a second sum including one or more weighting multipliers, each weighting multiplier associated with one objective term;
adapting the processor to communicate the MOPF result to the display; and
configuring the processor to organize MOPF results for each of multiple project choices into a digital rendering.

12. The method of claim 11, further comprising:
configuring the processor to organize MOPF results for each of multiple project choices into a geospatial rendering, wherein each MOPF result corresponds to favorability magnitude of the project choice.

13. The method of claim 11, further comprising:
providing a downloadable software application, and configuring the downloadable software application to communicate to the processor instructions for executing the MOPF, and further configuring the downloadable software application to communicate to the processor instructions for organizing MOPF results for each of multiple project choices into the digital rendering.

14. The method of claim 11, wherein said project is evaluating resource allocation for food production for a region.

15. The method of claim 13, further comprising:
configuring the downloadable software application to instruct the processor to register objective data to be considered by the MOPF.

16. The method of claim 12, wherein the geospatial rendering is at least one selected from the group of a raster plot and a vector plot.

17. The method of claim 11, further comprising determining objective data to be considered by the MOPF based on consideration of a number of planning objectives.

18. The method of claim 11, further comprising determining a function to be included in an objective term of the MOPF based on consideration of a number of planning objectives.

19. A system for valuing and comparing certain choices for project development, the system comprising:
a processor, configured with instructions to execute an MOPF, the MOPF including one or more objective terms;
a display;
wherein the MOPF is adapted to provide an MOPF result for a project choice;
wherein the MOPF comprises a first sum including one or more objective terms divided by a second sum including one or more weighting multipliers, each weighting multiplier associated with one objective term;
wherein the processor is adapted to communicate the MOPF result to the display;
wherein the processor is configured to organize MOPF results for each of multiple project choices into a digital rendering;
wherein the MOPF is adapted to provide MOPF results for objective data across one or more dimensions;
wherein each MOPF result corresponds to favorability magnitude of the project choice; and
wherein a number of planning objectives determine objective data to be considered by the MOPF.

20. The system of claim 19, wherein:
the processor is further configured to organize MOPF results for each of multiple project choices into at least one selected from the group of a raster plot and a vector plot; and
wherein the plot represents favorability for project development of different parcels of land across a particular topography.
